(19) United States
(12) Patent Application Publication
(10) Pub. No.: US 2015/0364048 A1
(43) Pub. Date: Dec. 17, 2015

(54) Talk Bracelet and Bonding System

(71) Applicant: Muria Irine Nisbett, Tampa, FL (US)

(72) Inventor: Muria Irine Nisbett, Tampa, FL (US)

(21) Appl. No.: 14/302,601

(22) Filed: Jun. 12, 2014

(51) Int. Cl. G09B 3/00; A44C 25/00; B42D 1/00; A44C 5/20

(52) U.S. Cl. CPC G09B 3/00; A44C 5/20; A44C 25/007; B42D 1/00

(57) ABSTRACT

A bracelet is provided having a thematic set of charms that are signatures of ages in the life of a young woman. Each of the charms corresponds to a chapter in a bonding book that initiate a new stage in a girl's life. This book is utilized to assist a mother and daughter overcome any emotional difficulty in the problematic growth process so common in the complex modern world. Various discussion topics are provided therein for each year followed by corresponding final mother daughter signature pages.

### FIELD OF THE INVENTION

The present invention relates to a device utilized for describing the coming of age of persons; more particularly, the invention relates to devices and a system to mark and learn from each stage of growth in a relationship between mother and daughter.

### BACKGROUND OF THE INVENTION

1. Related Art

One prior art system for training systems to perform various tasks is described in U.S. Pat. No. 5,851,117 issued on Dec. 12, 1998 and awarded to Keith A. Alsheimer et al. This patent presents a building block training system and method of training of cleaners of facilities to be used on the job which utilizes a plurality of pictorial displays. These show a specific set of steps to accomplish a cleaning operation in an efficient safe manner, e.g., dusting or vacuuming of a facility as well as a plurality of pictorial displays as to what must not be missed and must be avoided in performing the cleaning operation. Thus, a user interprets these displays and performs a sequence of cleaning functions.

2. Problem in the Prior Art

However, nothing in the prior art teaches a system of how a mother and daughter can bond during certain coming of age landmarks that take place in a young woman's life. Further, nothing in the prior art shows how they can learn from each stage and grow therefrom in a deepening relationship through the years. Nor is their a lasting sign indicative of the growing relationship between parent and child and the maturity of the youngster.

Accordingly, there needs to be some solution to overcome the aforementioned problems.

### SUMMARY OF THE INVENTION

The present invention overcomes the deficiencies of the known art and the problems that remain unsolved by providing a novel Talk Bracelet and Bonding System as herein described.

A bonding tool comprising:
a bracelet having a length and two ends thereof such that the length terminates in a clasp attachment at either end so that the clasp attachments can be engaged together and
a first signature charm loaded onto the bracelet.

In another aspect, further comprising:
a second signature charm loaded onto the bracelet.

In another aspect, further comprising:
a plurality of signature charms loaded onto the bracelet.

In another aspect, wherein the signature charm comprises:
a thematic charm.

In another aspect, wherein the signature charm comprises:
a thematic charm.

In another aspect, wherein the signature charm further comprises interaction with a bonding system related to the signature charm.

In another aspect, wherein the plurality of signature charm further comprises interaction with a bonding system related to the plurality of signature charms.

A bonding system comprising:
a young woman's personal growth handbook having a plurality of leaves including a sequence of chapters therein such that
   the chapters each have an introductory image and statement relating to a unique bracelet charm.

In another aspect, wherein each of the chapters further comprises:
a set of discussion topics relating to a future year in the life of the young woman.

In another aspect, wherein each of the discussion topics further comprises:
a new page having a discussion title at a top thereof and a writing space below the aforementioned title.

In another aspect, further comprising:
a mother end statement.

In another aspect, further comprising:
a mother signature space.

In another aspect, further comprising:
a daughter end statement.

In another aspect, further comprising:
a daughter signature space.

A method of using a thematic signature device comprising steps of:
reading a beginning of a chapter in a bonding tool
providing the thematic signature device to a user by attachment to a bracelet thereon.

In another aspect, further comprising the steps of:
reading a discussion topic.

In another aspect, further comprising the steps of:
inscribing ideas relating to the discussion topic in the bonding tool.

In another aspect, wherein the steps of:
reading a beginning of a chapter in a bonding tool
providing the thematic signature device to a user by attachment to a bracelet thereon and
reading a discussion topic and inscribing ideas relating to the discussion topic in the bonding tool are repeated until the end of the bonding tool.

In another aspect, further comprising the steps of:
reviewing the previous year's discussion at start of new year.

In another aspect, further comprising the steps of:
reviewing the current year's discussion at end of a year.

These and other aspects, features, and advantages of the present invention will become more readily apparent from the attached drawings and the detailed description of the preferred embodiments, which follow.

### BRIEF DESCRIPTION OF THE SEVERAL VIEWS OF THE DRAWINGS

The preferred embodiments of the invention will hereinafter be described in conjunction with the appended drawings provided to illustrate and not to limit the invention, in which:

FIG. 1A and FIG. 1B presents a physical description of the various components in an embodiment of the Talk Bracelet & Bonding System; FIG. 1A illustrates a top view of a Talk Bracelet; FIG. 1B illustrates a Bonding System as taught in an embodiment.

FIG. 2A represents a Snowflake Charm 6 in an embodiment herein.

FIG. 2B represents a Gems Charm in an embodiment herein.

FIG. 2C represents a Keys Charm in an embodiment herein.

FIG. 2D represents a Interlocking Hearts Charm in an embodiment herein.

FIG. 2E represents a The Number Charm in an embodiment herein.

FIG. 2F represents a Butterfly Charm in an embodiment herein.

FIG. 2G represents a Guardian Angel Charm in an embodiment herein.

FIG. 3A presents a high level overview of the various components in the Bonding System described herein in an embodiment.

FIG. 3B is an illustration of an introductory statement about the nature thereof describing the difficulty that a coming of age discussion is with a daughter in this day an age.

FIG. 3C is an illustration of a Table of Contents (TOC) on the following first page of the book.

FIG. 3D is an illustration of a picture, drawing or a place to affix one of the mother-daughter pair on the back of the TOC page.

FIG. 3E( ), FIG. 3F, FIG. 3G, FIG. 3H, FIG. 3I, FIG. 3J, FIG. 3K, FIG. 3L, FIG. 3M, FIG. 3N, FIG. 3O, FIG. 3P, FIG. 3Q are illustrations of several pages of descriptive language including corresponding poetry dealing with the emotional and personal feelings and challenges of the parental task ahead.

FIG. 3R is an illustration of a picture of the child, drawing or a place to affix one of the aforementioned as this section is a chance to speak out to the mother.

FIG. 3S is an illustration on the back of the picture page that has inspirational writing designed to connect young reader's with the used of the book as a sweet tool to grow yearly.

FIG. 3T, FIG. 3U, FIG. 3V, FIG. 3W, FIG. 3X, FIG. 3Y, FIG. 3Z are illustrations representing three full double sided pages of writings ending in another final page having one side concluding this writing.

FIG. 4A, FIG. 4B are illustrations of a two page description of the meaning of the Talk Bracelet & Bonding System.

FIG. 5 is an illustration of a page having a description 19 of each of the Charms and their respective meanings.

FIG. 6 is an illustration of the first page of the first year used in the Bonding System 5.

FIG. 7A, FIG. 7B, FIG. 7C, FIG. 7D, FIG. 7E, FIG. 7F, FIG. 7G, FIG. 7H, FIG. 7I, FIG. 7J. are illustrations of the first year discussion topics. FIG. 7A is a front illustration of a discussion page about My Period. FIG. 7B, is a front illustration of a discussion page about My Body is Changing. FIG. 7C is a front illustration of a discussion page about Questions About My Body. FIG. 7D is a front illustration of a discussion page about A Few of My Favorite Things Are. FIG. 7E is a front illustration of a discussion page about What I Like Most About Myself FIG. 7F is a front illustration of a discussion page about When I Grow Up I Want to Be. FIG. 7G is a front illustration of a discussion page about I Will Live Above the Influence of Drugs and Alcohol because. FIG. 7H is a front illustration of a discussion page about I Will Remain Abstinent Because. FIG. 7I is a front illustration of a discussion page about Other Interesting Topics. FIG. 7J is a front illustration of a discussion page about Review of Session.

FIG. 8A) is an illustration of the Guardian Angel relating to the final charm. FIG. 8B is an illustration of the back of the previous page that has an image of a mother daughter pair or a space for the attachment of a photo thereof and a statement of the finality of the Final Talk as the Bracelet is complete. FIG. 8C is the next page and is a double sided page having lines thereon.

FIG. 8D is the final page and is a double sided page having a Mother's declaration and signature space on one side; on the other side FIG. 8E has a Daughter's declaration and signature space as a separate illustration.

FIG. 9 presents a flowchart of how the Bonding System is to be used in the Talk Bracelet & Bonding System in an embodiment herein.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

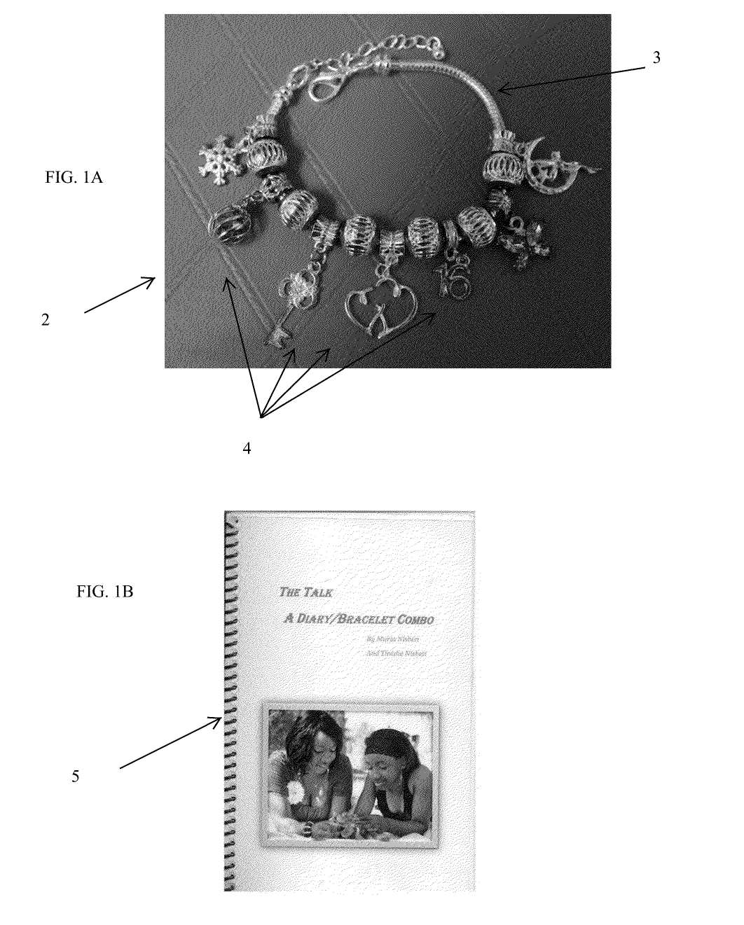

FIG. 1A and FIG. 1B presents a physical description of the various components in an embodiment of the Talk Bracelet & Bonding System; FIG. 1A illustrates a top view of a Talk Bracelet; FIG. 1B illustrates a Bonding System as taught in an embodiment. The Talk Bracelet & Bonding System 1 comprises a Talk Bracelet 2 having a Bracelet 3 and a sequence of age related Charms 4. The Bracelet has various links (chain etc) and a mechanism for clasping one end of the bracelet to its opposite end. It is given to a young lady typically at the age of 12, however, it is understood that the start of the process can be younger or older depending on the needs of the implementation.

A Charm 4 is given at the start of each year and a Talk is initiated representing various suggested topics with locations for the daughter to make notations within the Bonding System 5 shown in FIG. 1B. This Bonding System 5 is typically a spiral bound notebook having various written portions describing in detail the particular stage in coming of age that is to be represented by a charm given at the commencement thereof; additionally, several proposed topics are included therein regarding discussion possibilities between mother and daughter adjacent to a lined or unlined space presenting a writing location for thoughts between the parent and child. It should be understood that alternative types of binding (perfect binding, saddle stitching, etc.) are likewise understood as an alternative method of manufacture of the Bonding System.

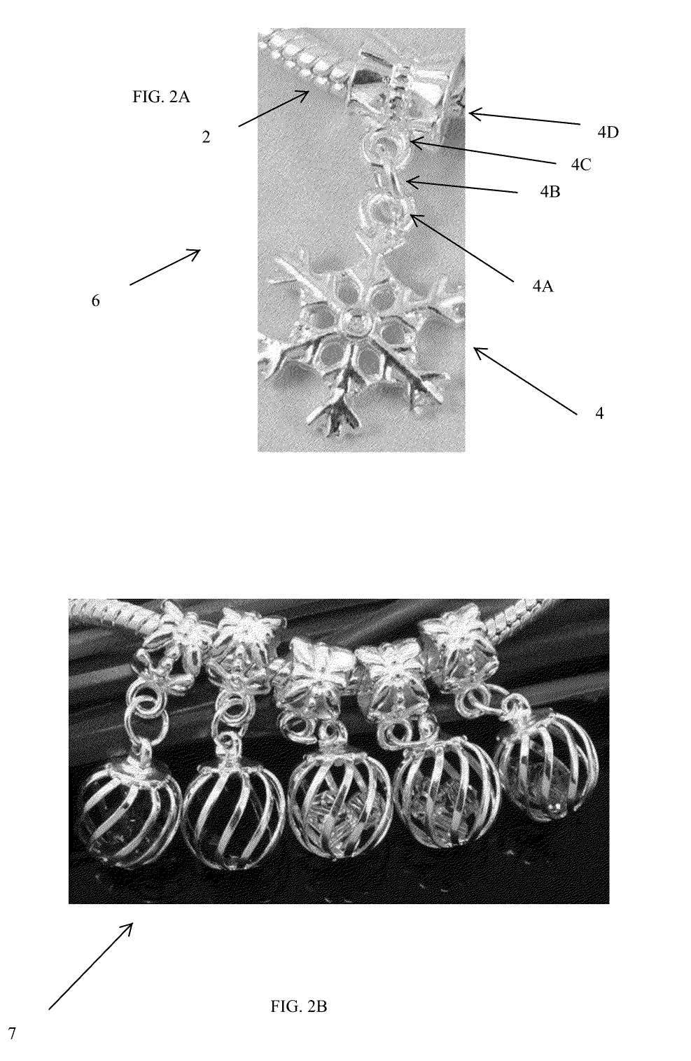

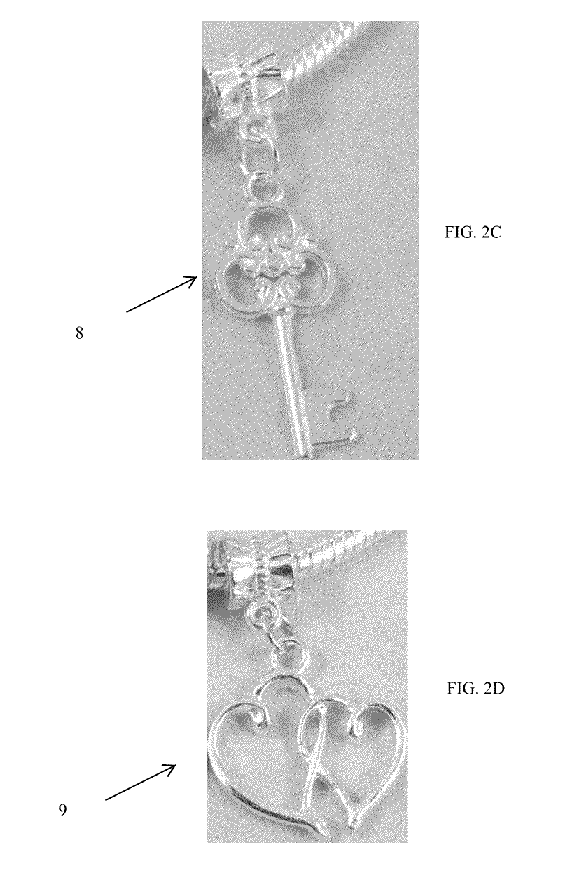

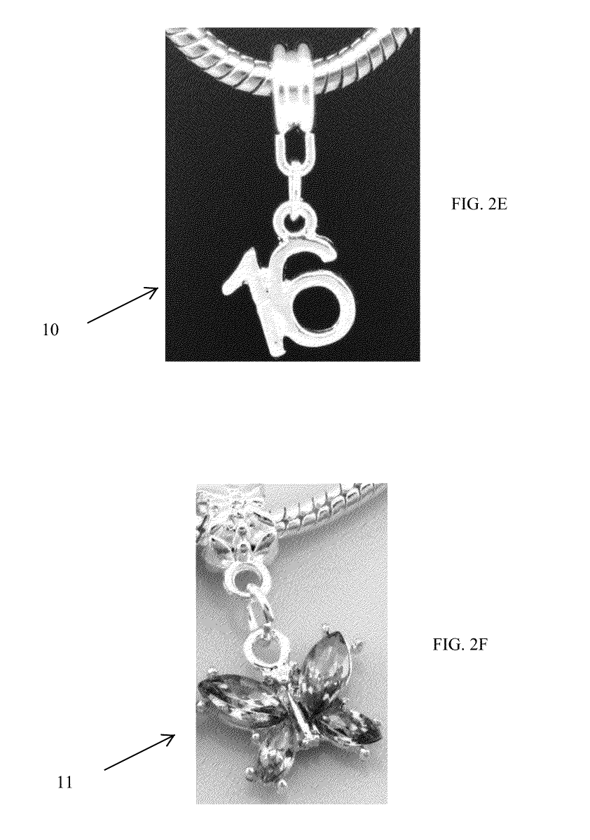

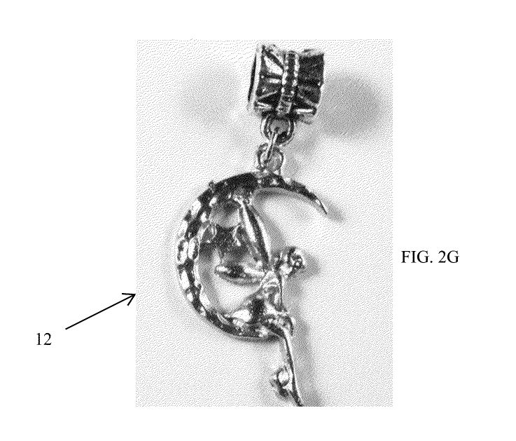

FIG. 2A represents a Snowflake Charm 6 in an embodiment herein. It should be understood that the other charms 4 are similarly arranged as the Snowflake Charm 6 with regards to the mechanism of attachment to the bracelet 3. The Talk Bracelet 2 is comprised of a Bracelet 3 and a sequence of charms 4. The Bracelet 3 has a series of links or other type of connectors (rope, chain) ending in a jewelry clasping arrangement such that the Bracelet 3 is useable on the wrist of an individual.

Upon this Bracelet 3 is a sequence of Charms 4 having an integral loop 4A of material utilizing a loose loop 4B threaded within the integral loop 4A; this loose loop 4B is also threaded within an integral loop 4C of a bracelet holder 4D. It is this bracelet holder 4D that wraps around the bracelet 2 itself or is threaded thereon by sliding it upon the bracelet 3. Thus, the charms 4 are made to engage the bracelet 3 thereby making the Charm 4 slidable thereupon. It should be recognized from the Charms 4 that each one represents a milestone or hallmark of a young woman's life that corresponds to a written or poetic initiation summary that is displayed at the beginning of each chapter in the Bonding System 5 as described below. The charms 4 are a signature of the various emotional and thematic elements relating to that particular stage of a girl's development.

FIG. 2B represents a Gems Charm 7 in an embodiment herein.

FIG. 2C represents a Keys Charm 8 in an embodiment herein.

FIG. 2D represents a Interlocking Hearts Charm 9 in an embodiment herein.

FIG. 2E represents a The Number 16 Charm 10 in an embodiment herein.

FIG. 2F represents a Butterfly Charm 11 in an embodiment herein.

FIG. 2G represents a Guardian Angel Charm 12 in an embodiment herein.

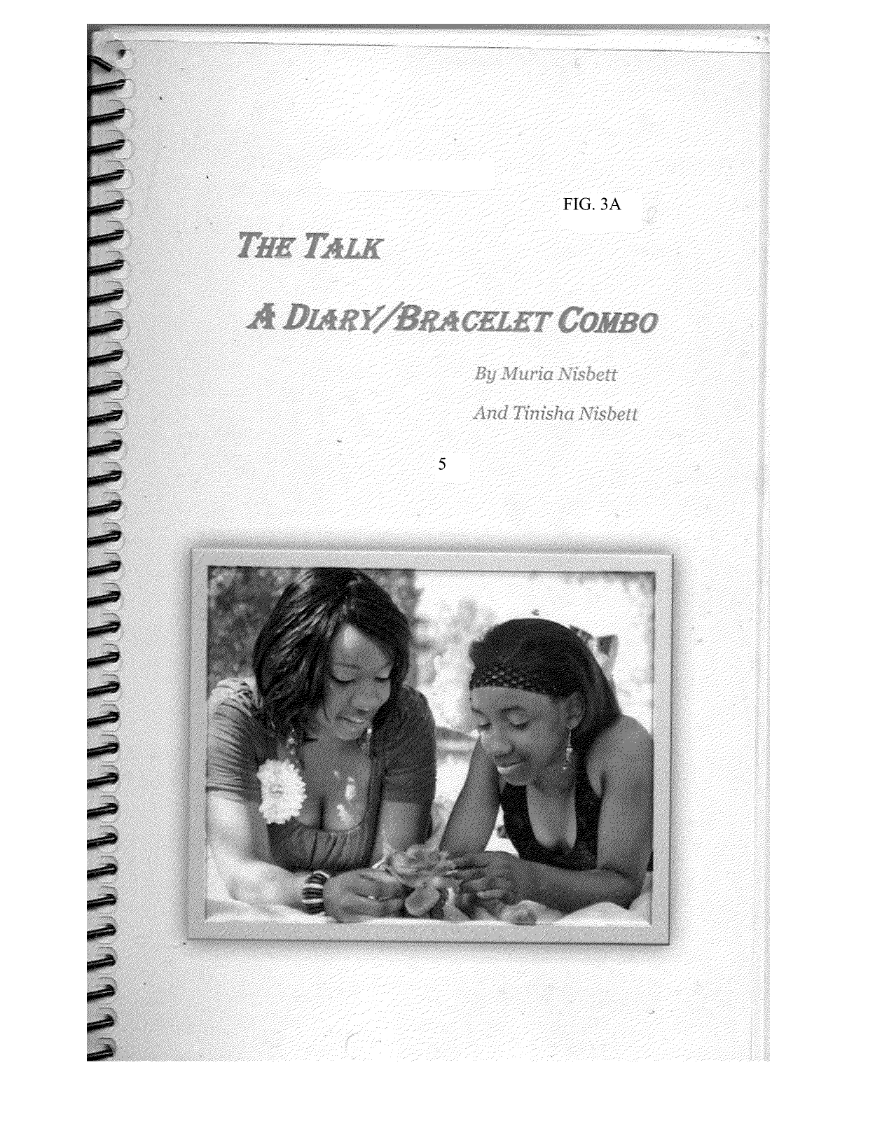

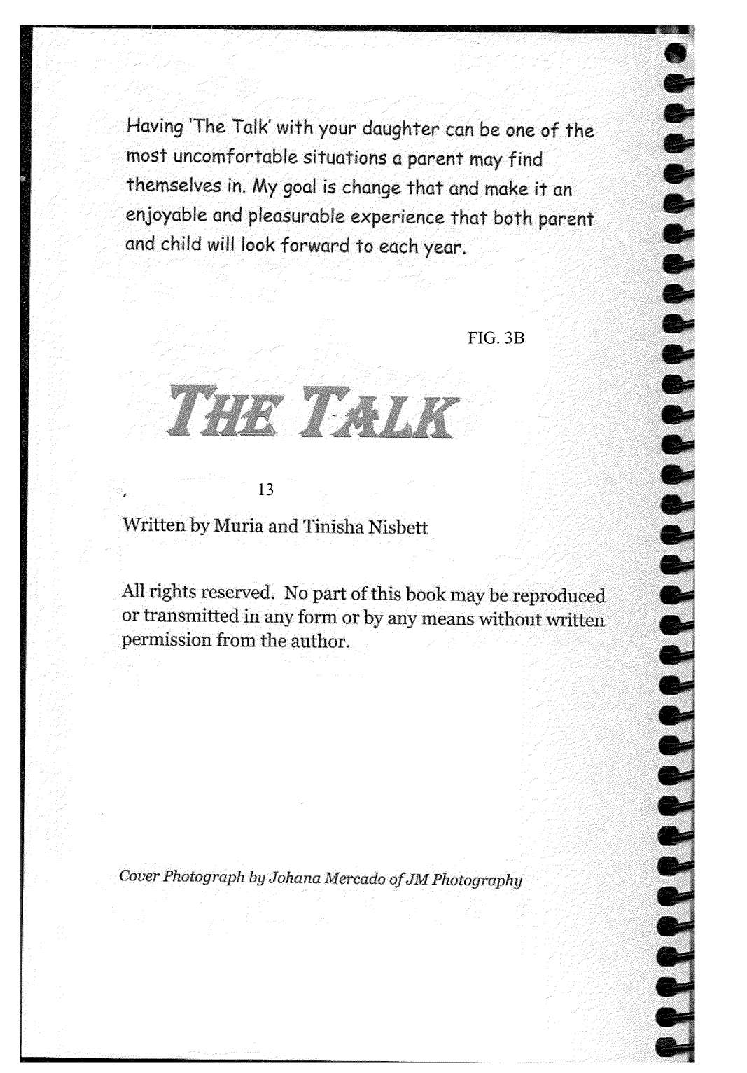

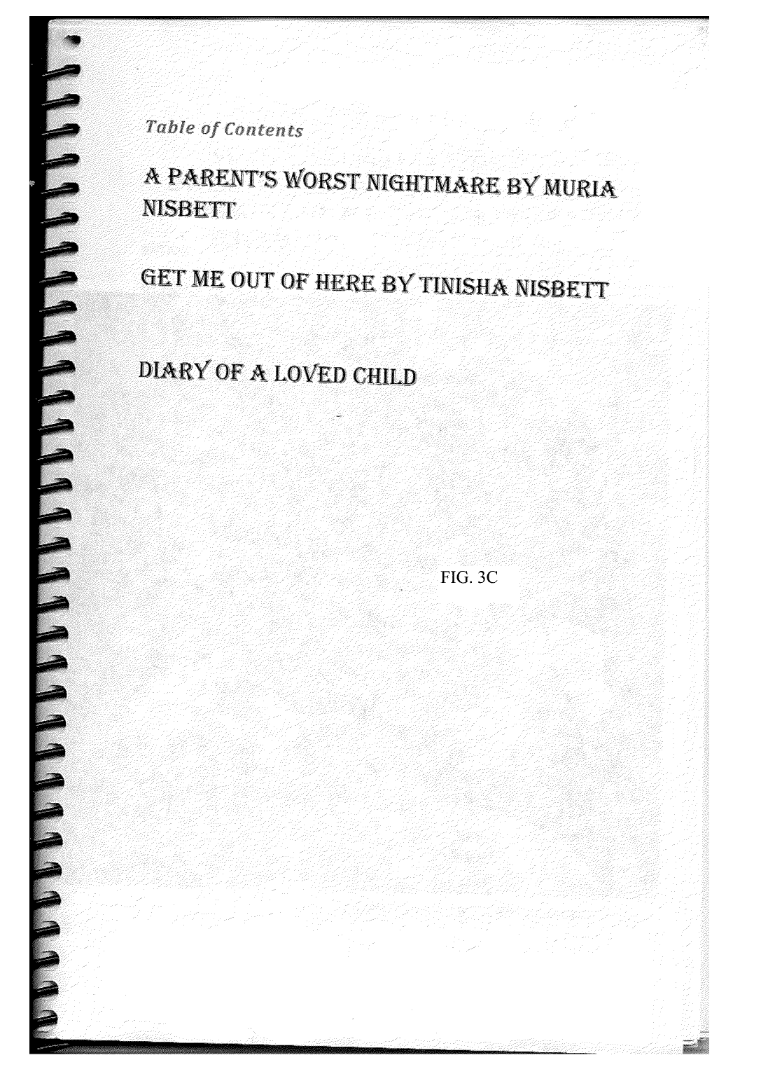

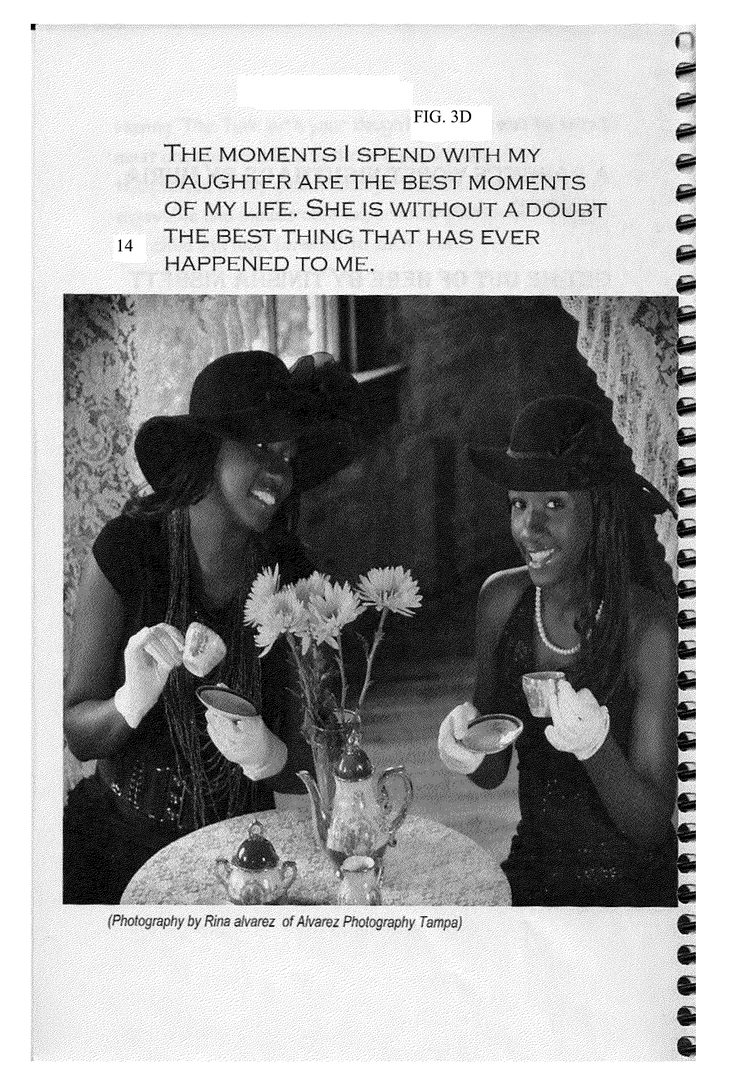

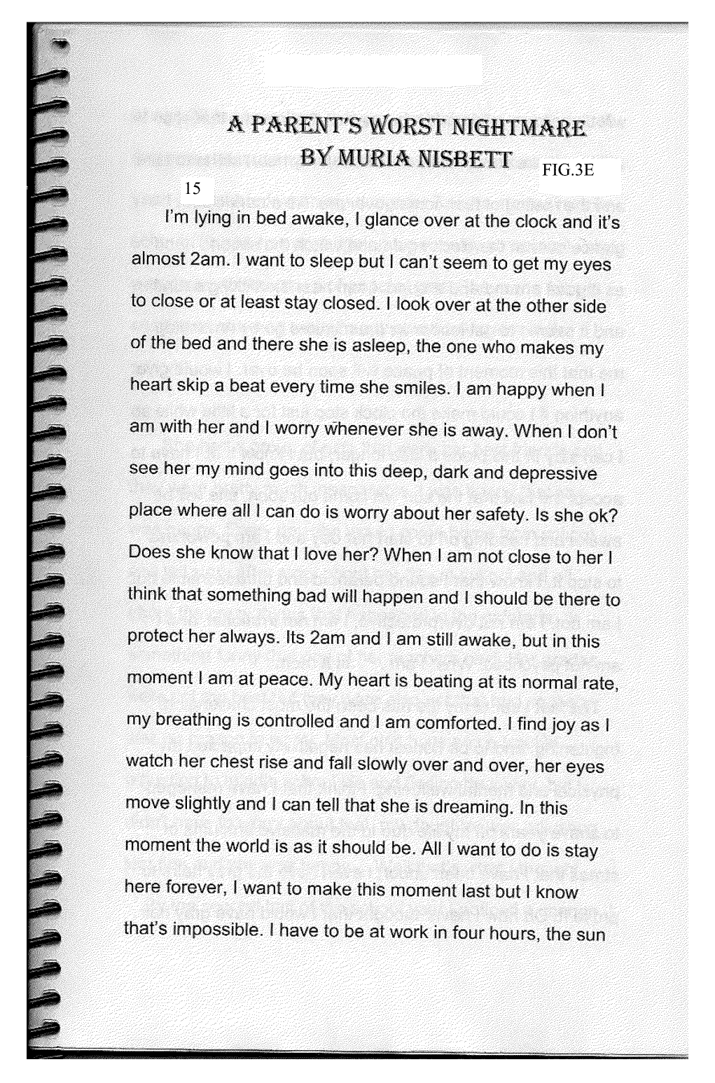

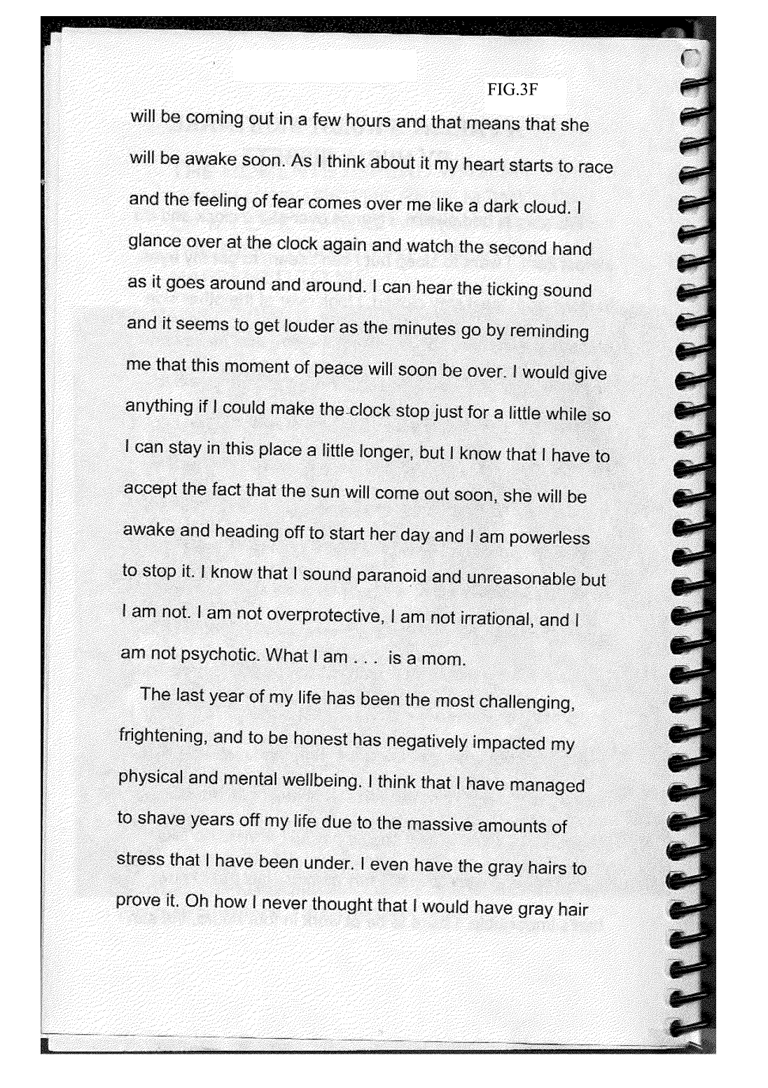

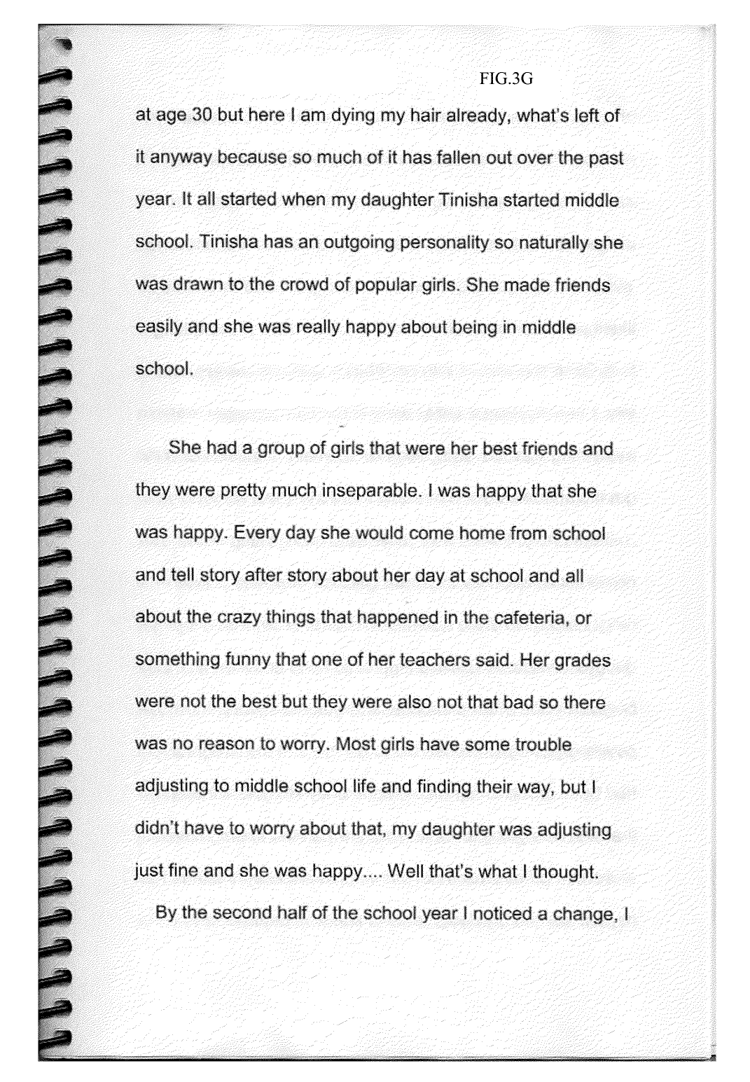

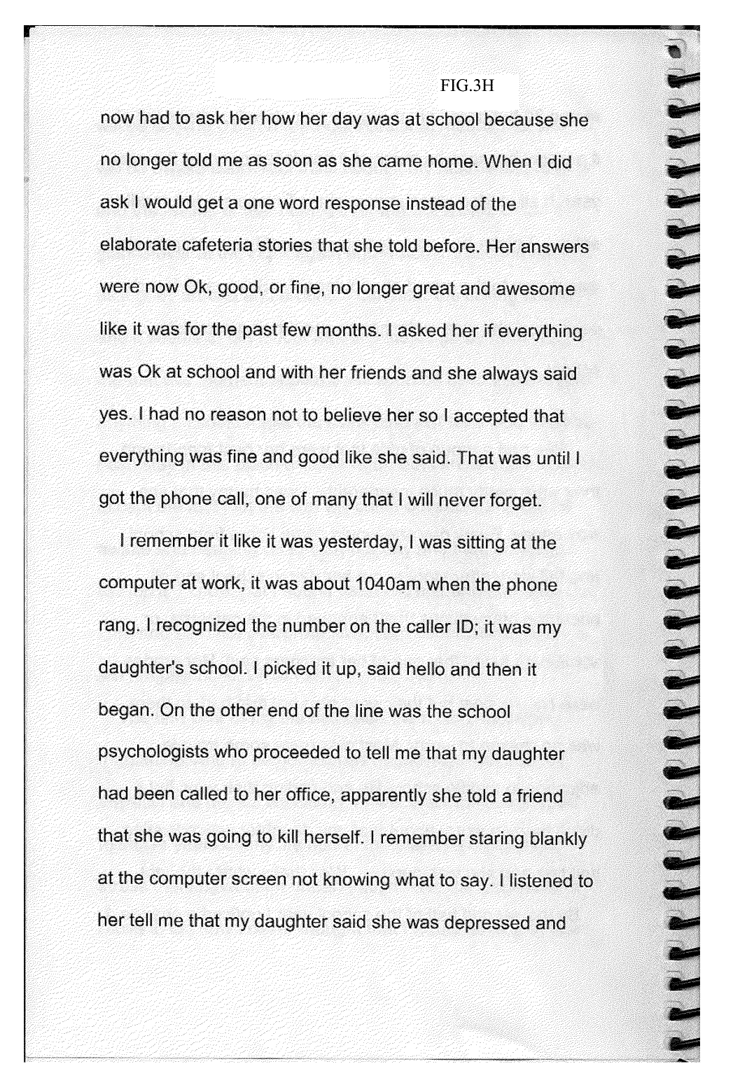

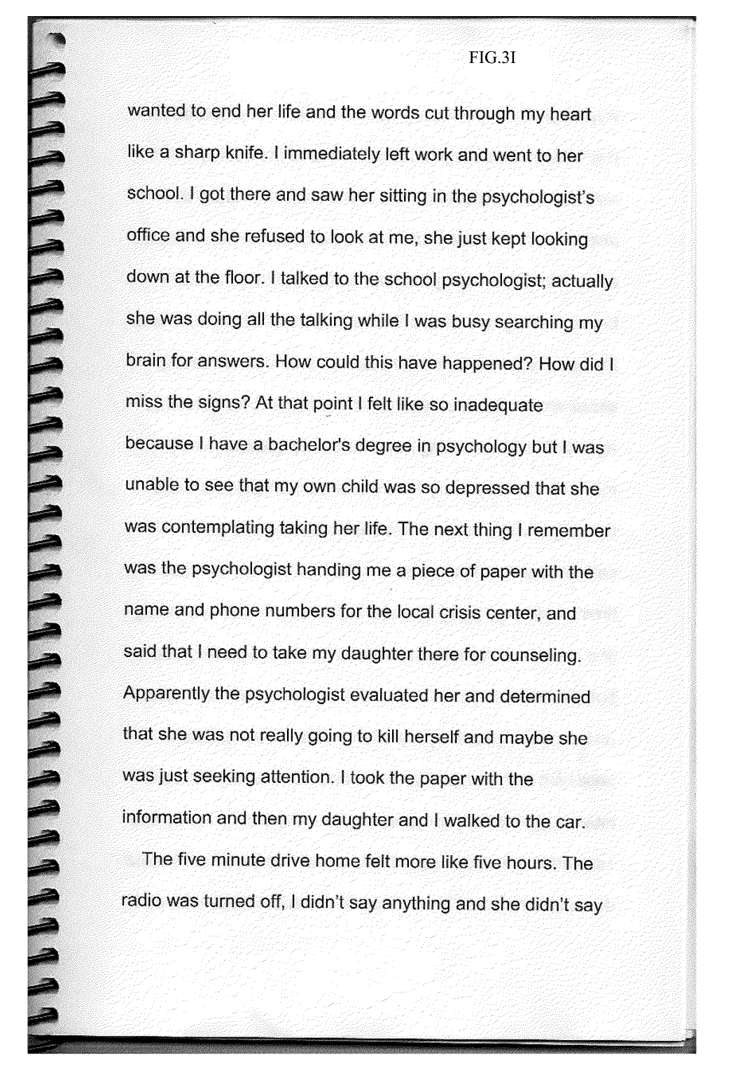

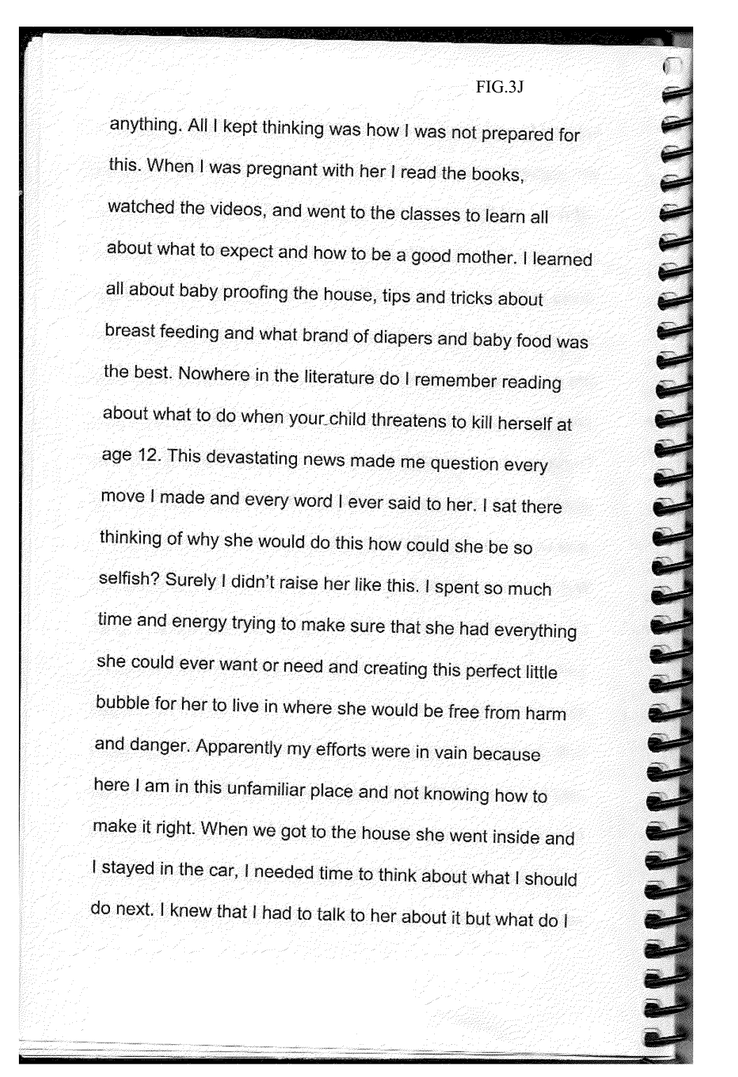

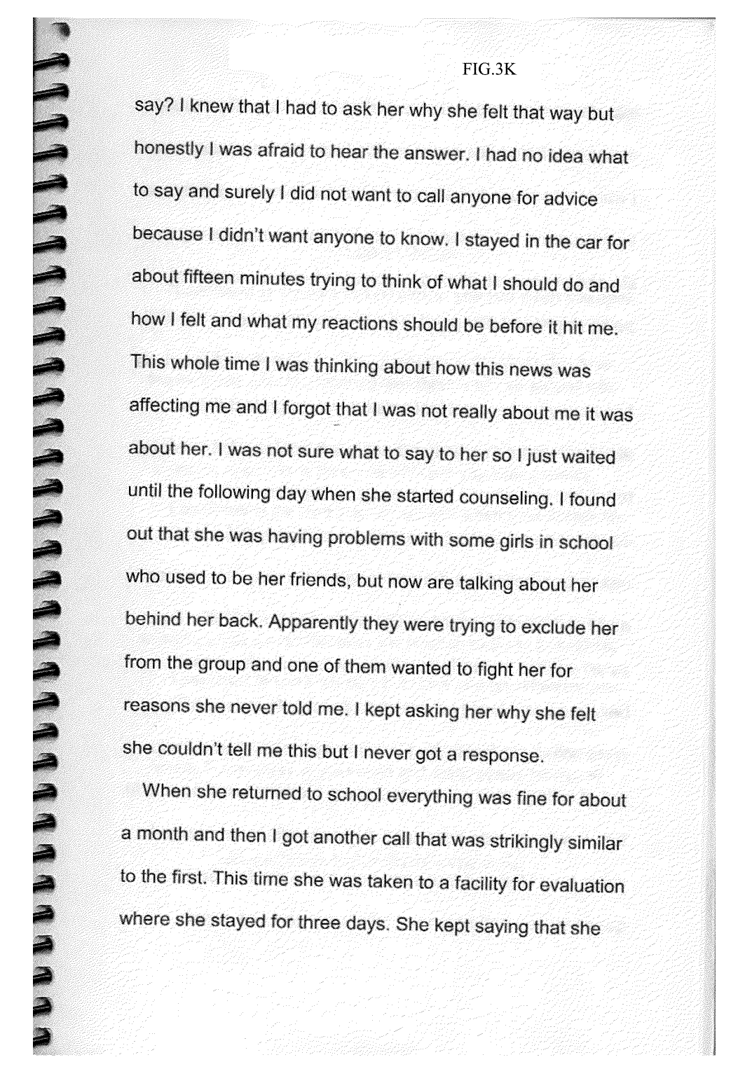

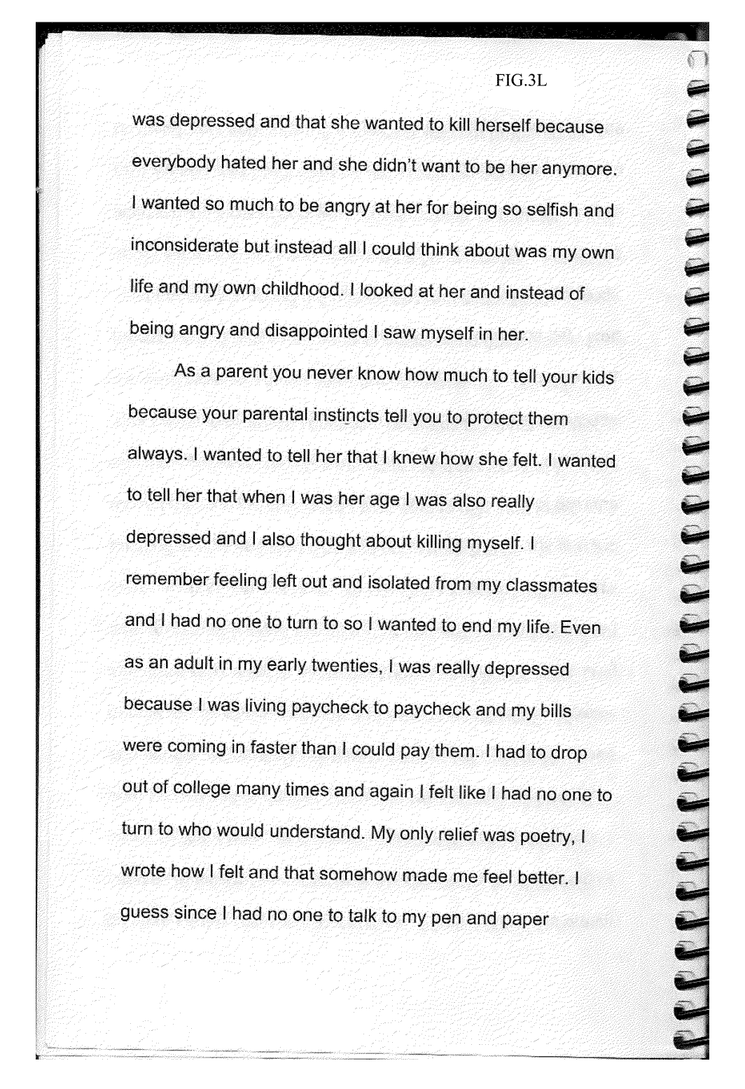

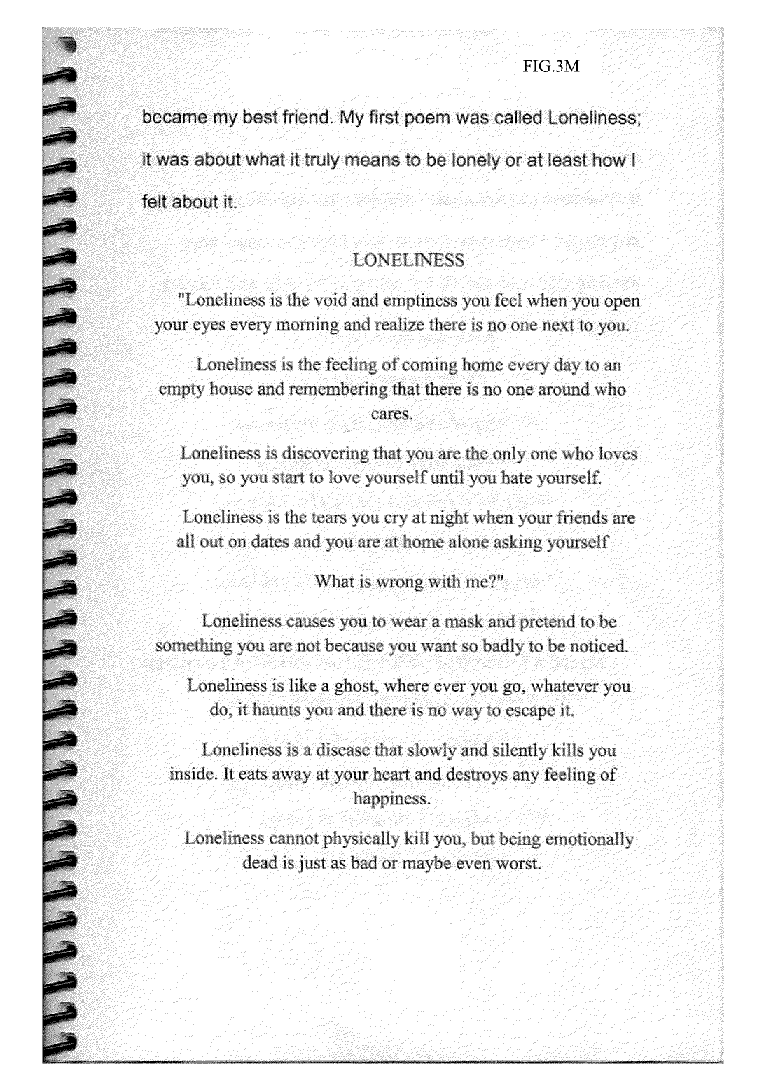

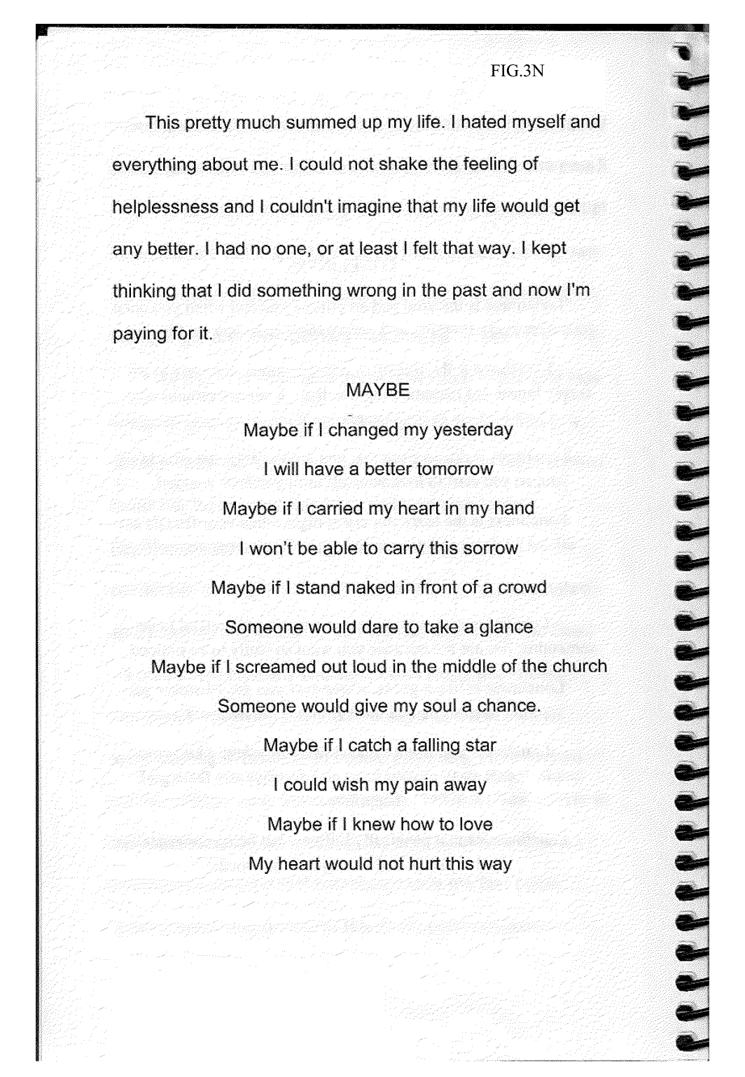

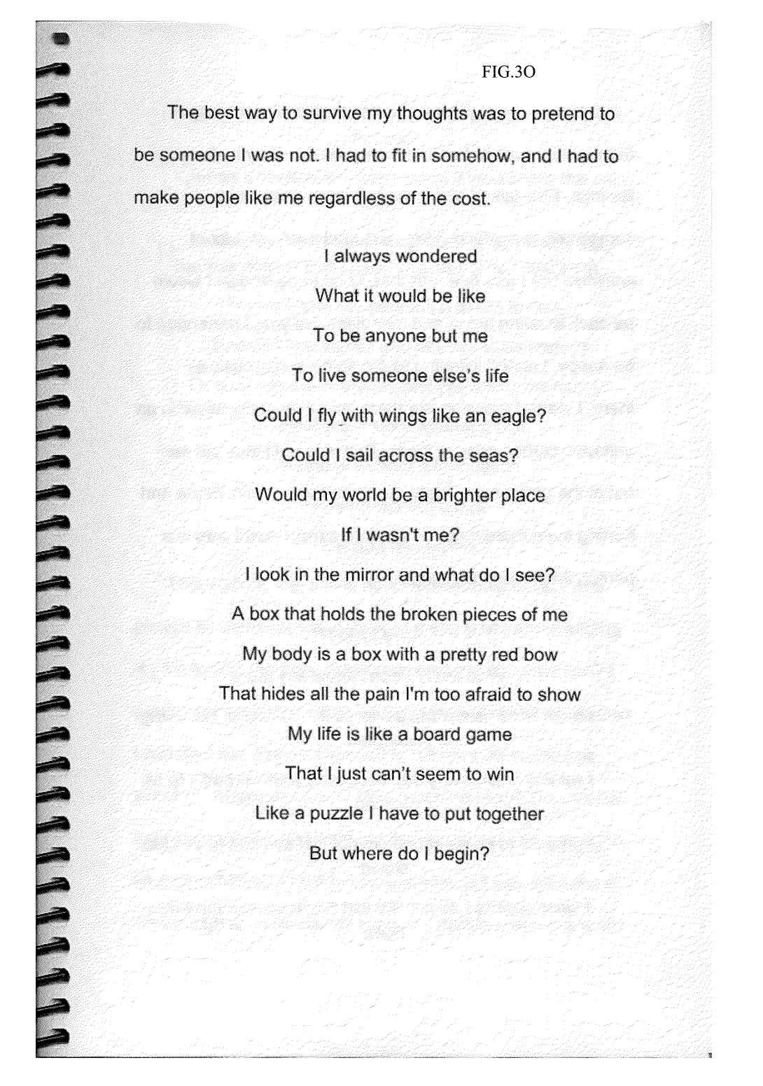

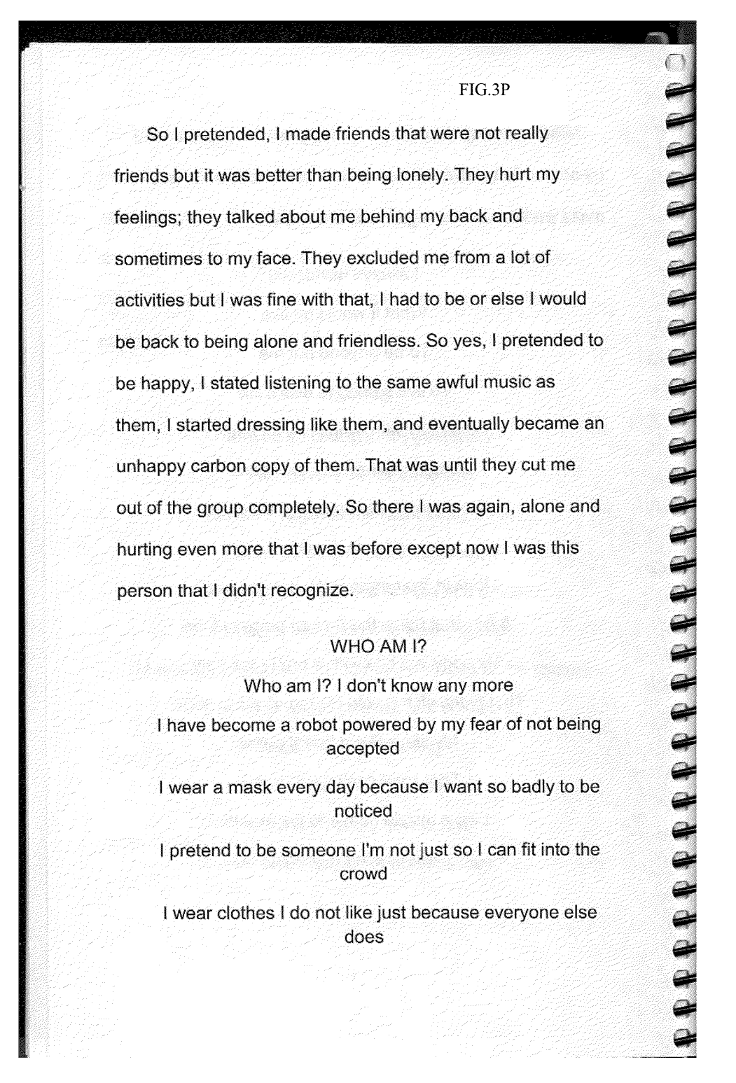

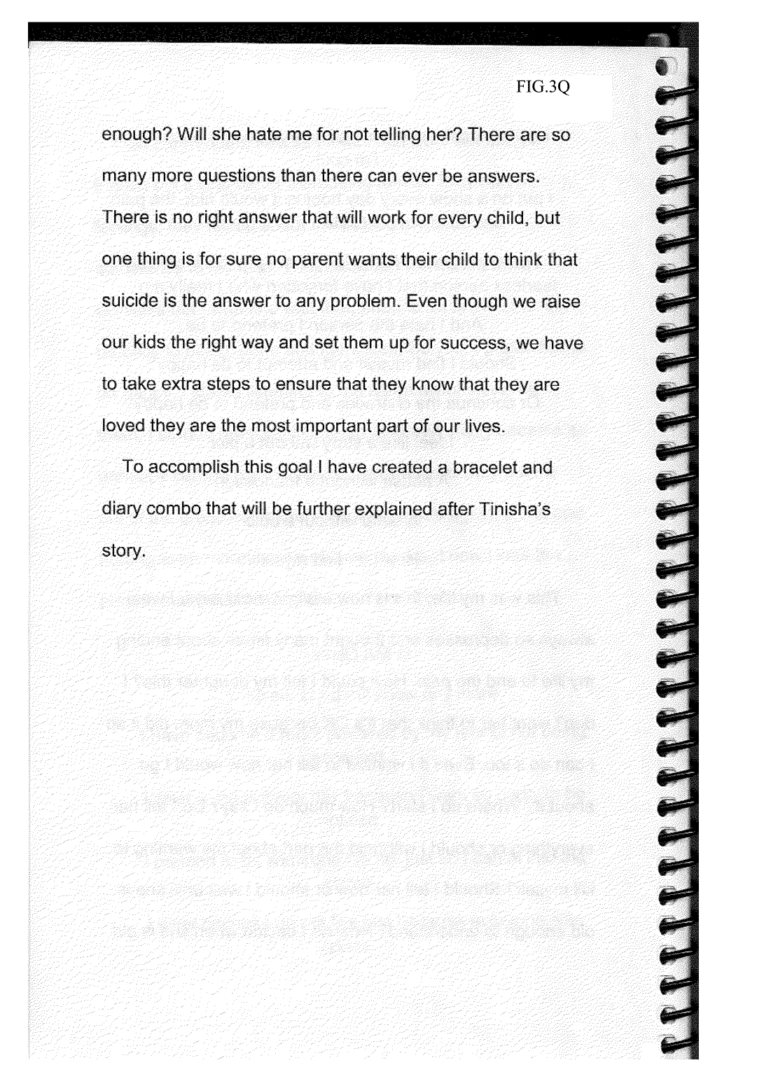

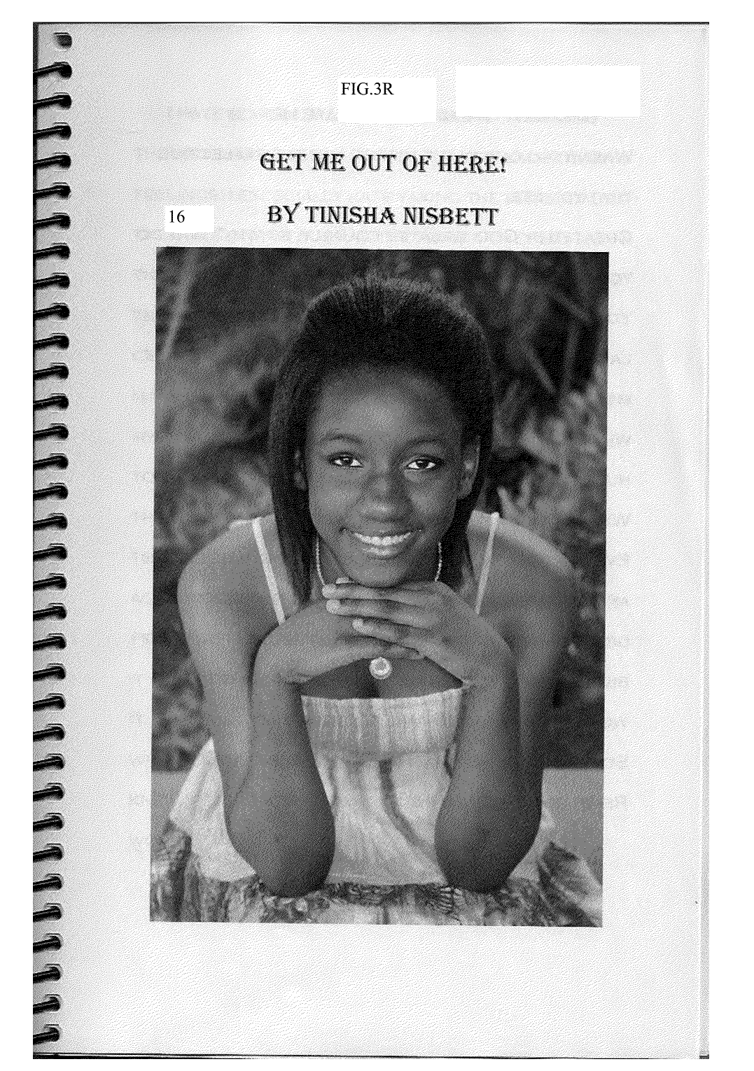

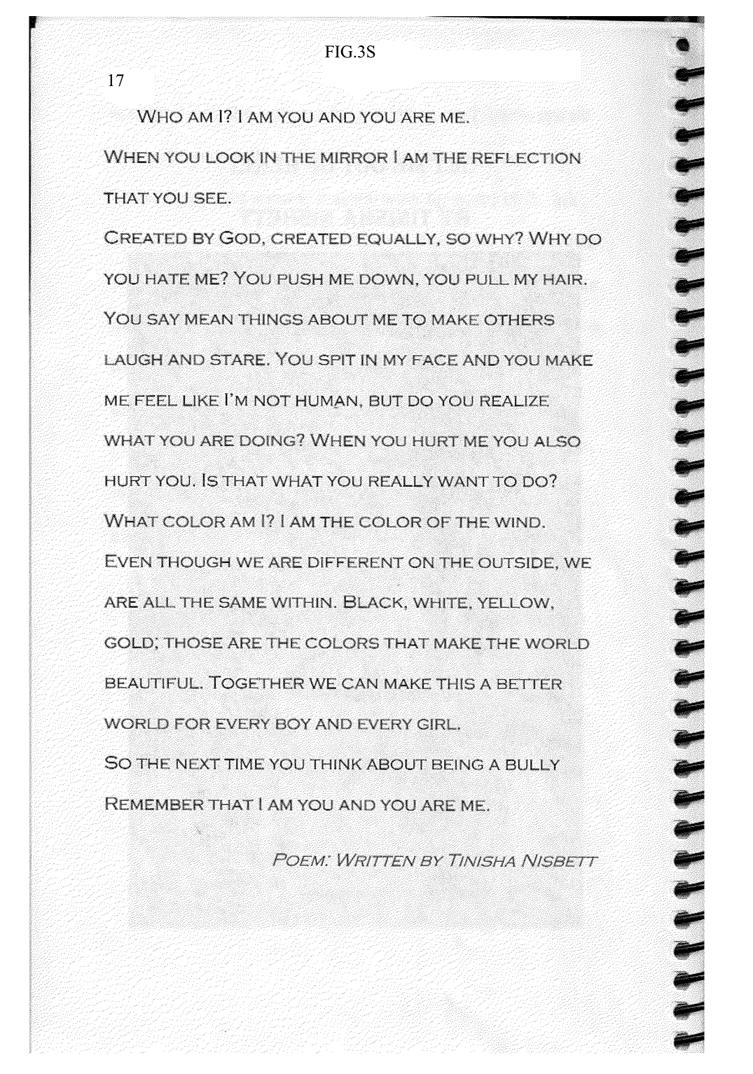

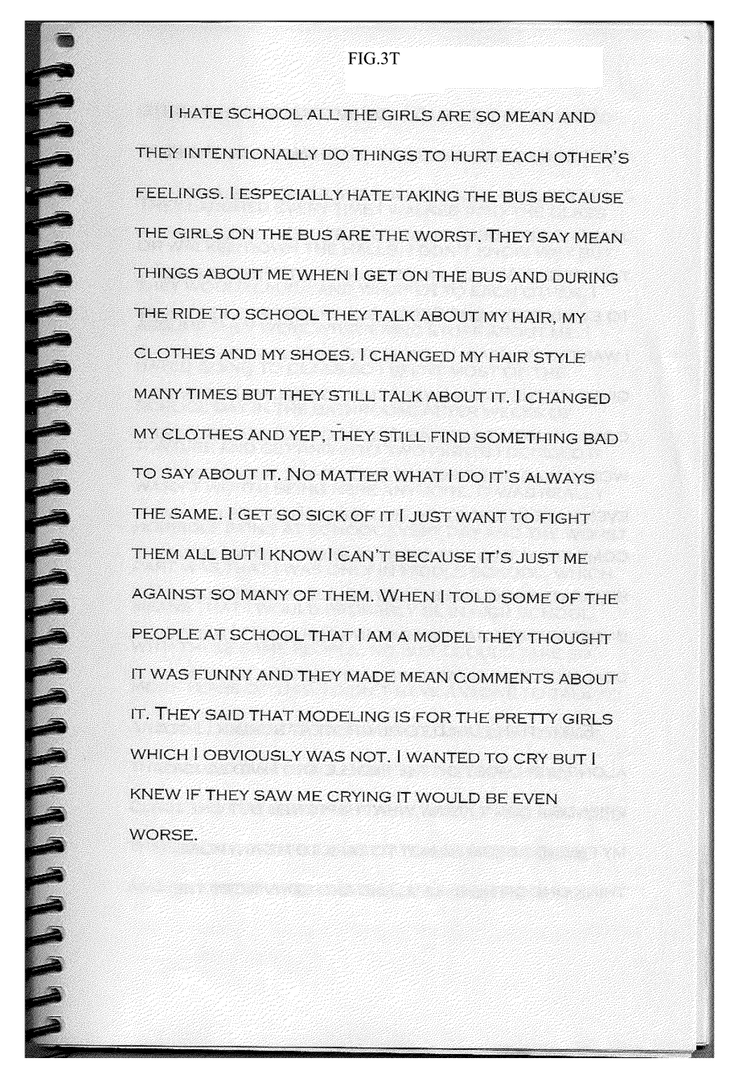

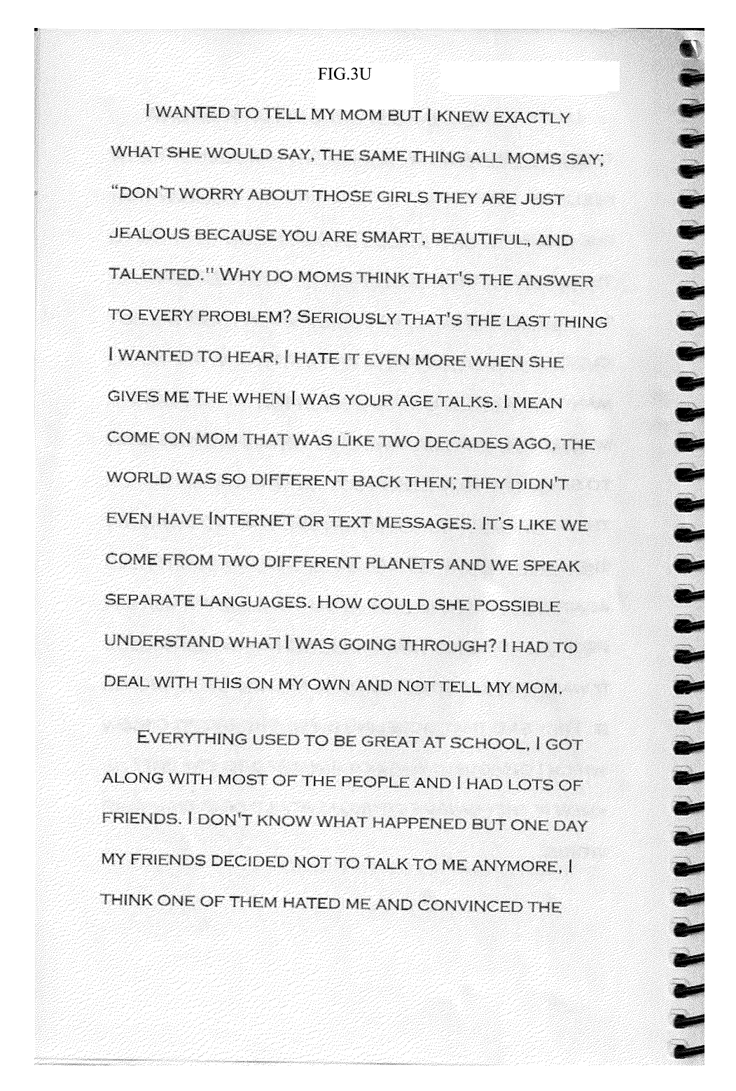

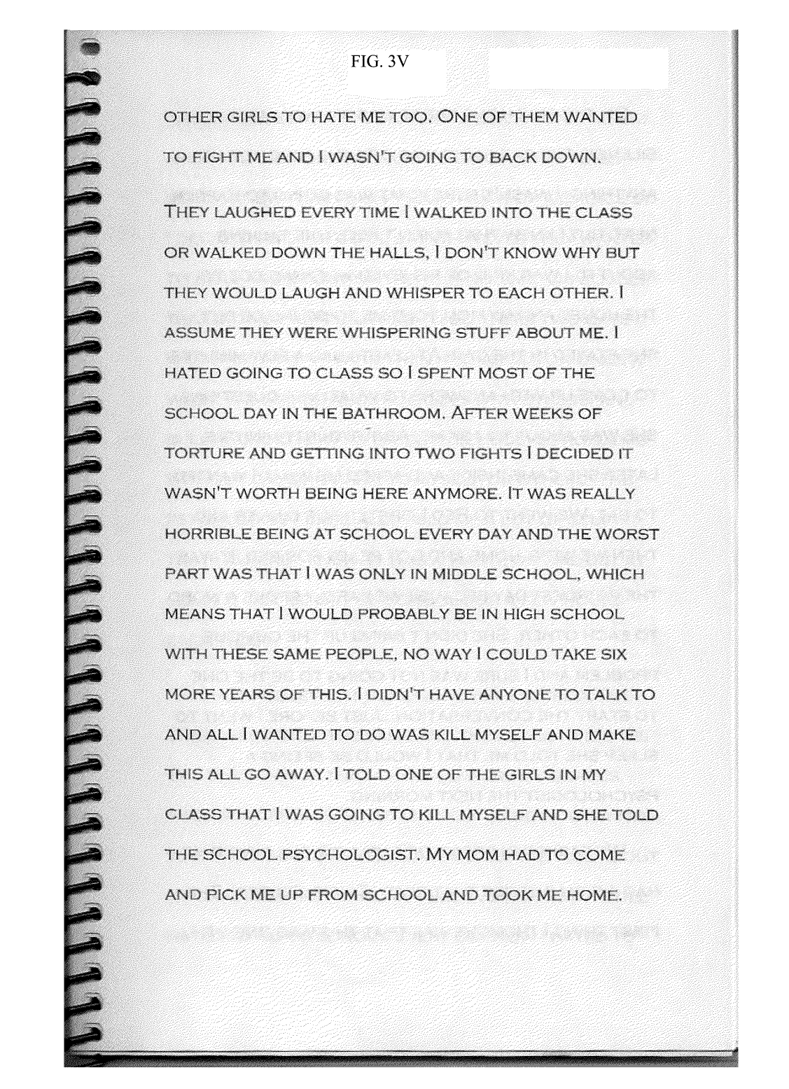

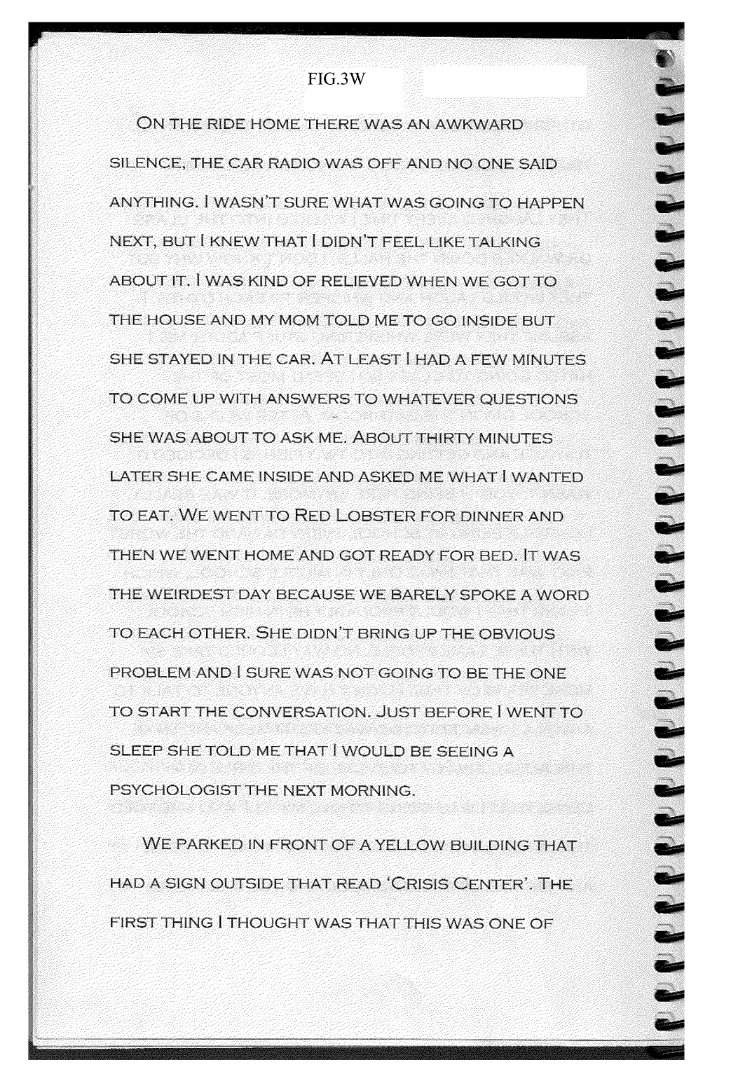

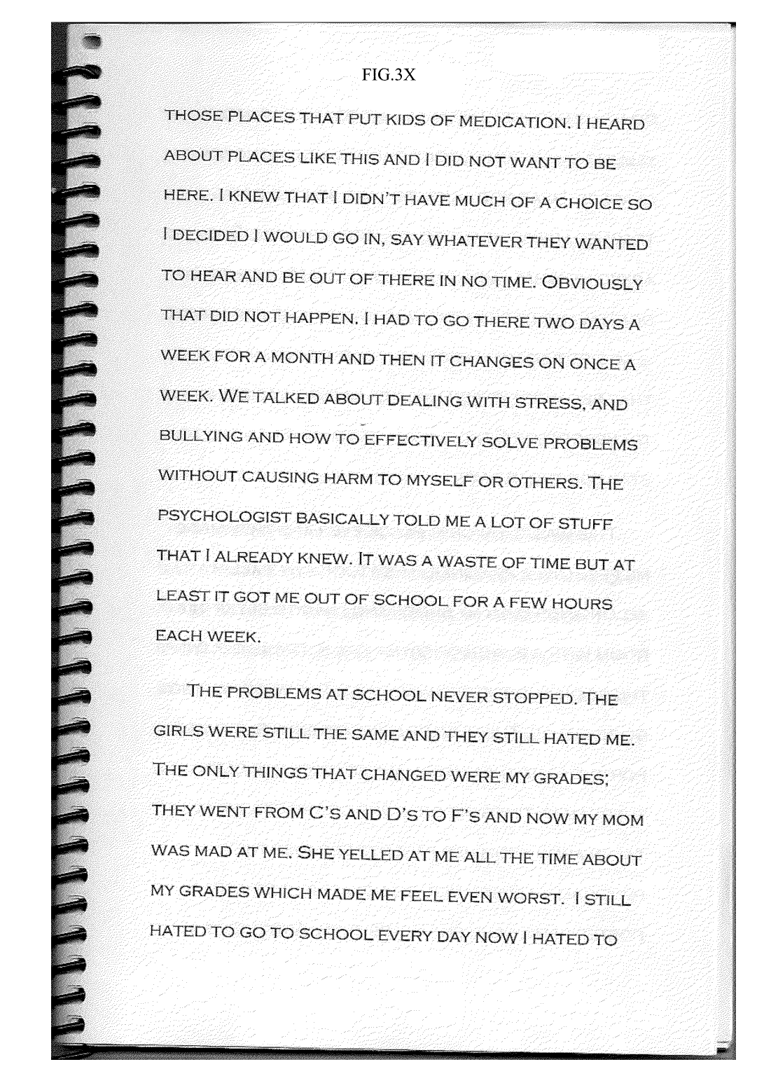

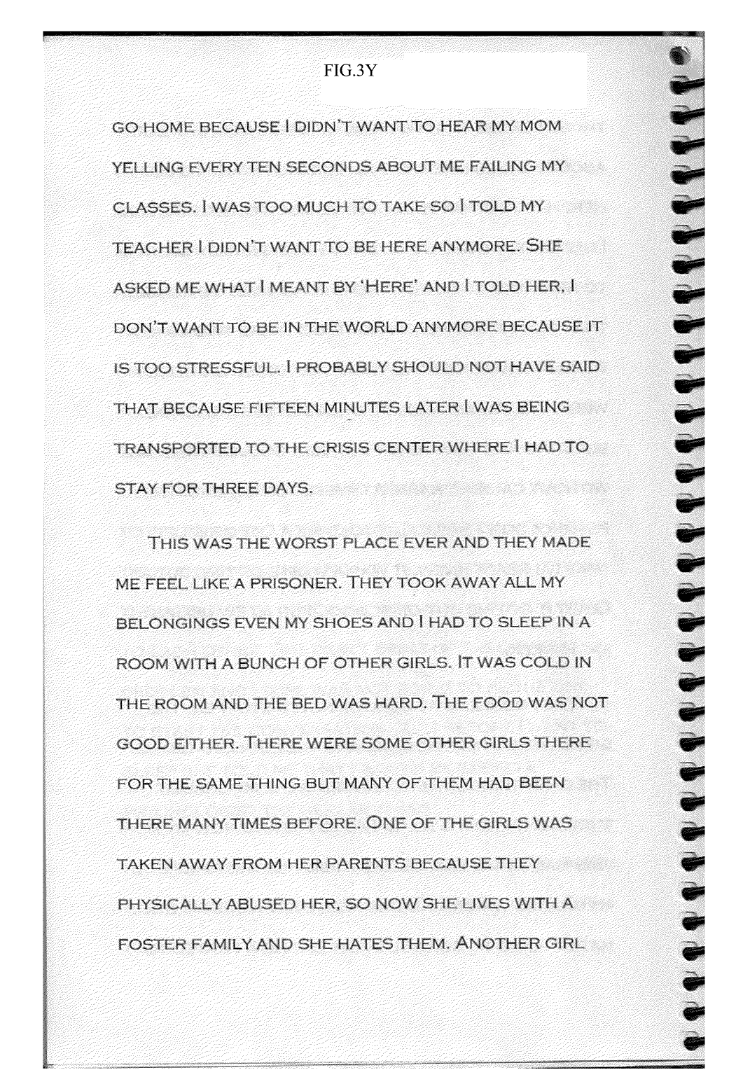

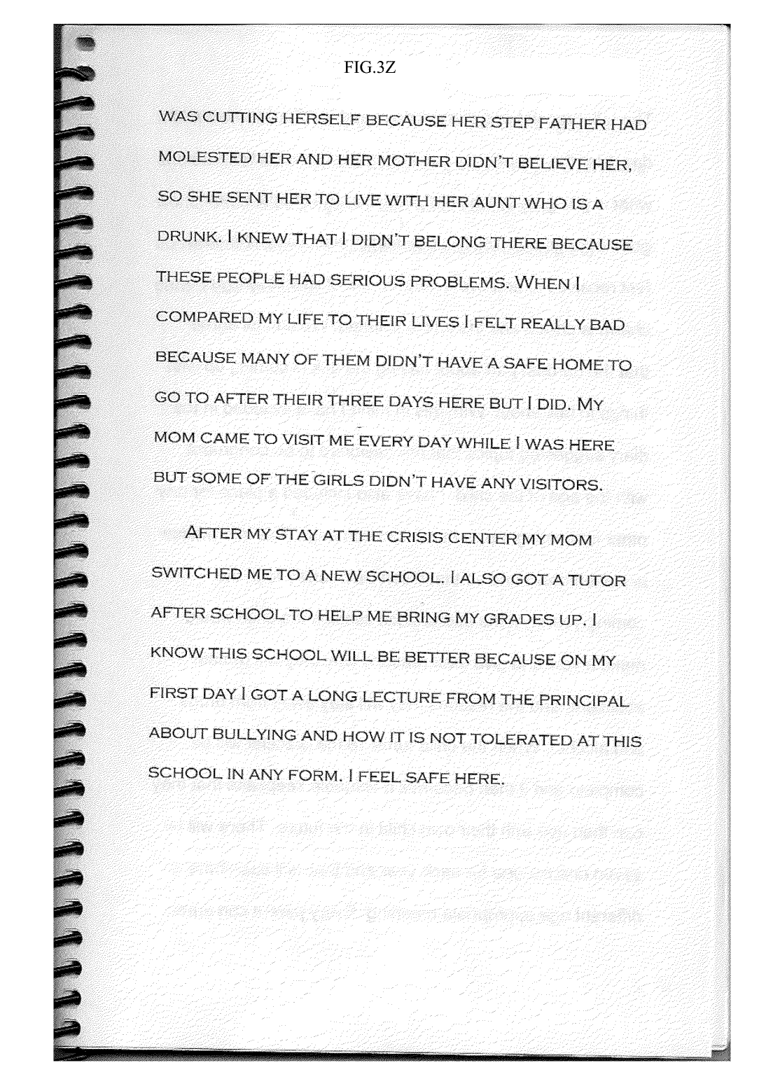

FIG. 3A presents a high level overview of the various components in the Bonding System described herein in an embodiment. The Bonding System 5 is typically a spiral bound notebook having various written portions describing in detail the particular stage in coming of age that is to be represented by a charm given at the commencement thereof; alternative types of binding (perfect binding, saddle stitching, etc.) are likewise understood as an alternative method of manufacture of the Bonding System 5.

FIG. 3B is an illustration of an introductory statement 13 about the nature thereof describing the difficulty that a coming of age discussion is with a daughter in this day an age; this is found in the inside front cover thereof.

FIG. 3C is an illustration of a Table of Contents (TOC) on the following first page of the book.

FIG. 3D is an illustration of a picture, drawing or a place 14 to affix one of the mother-daughter pair on the back of the TOC page; alternatively, a graphic of the author-daughter pair is printed herein.

FIG. FIG. 3F, FIG. 3G, FIG. 3H, FIG. 3I, FIG. 3J, FIG. 3K, FIG. 3L, FIG. 3M, FIG. 3N, FIG. 3O, FIG. 3P, FIG. 3Q are illustrations of several pages of descriptive language 15 including corresponding poetry dealing with the emotional and personal feelings and challenges of the parental task ahead.

FIG. 3R is an illustration of a picture of the child, drawing or a place to affix one of the aforementioned as this section is a chance to speak out to the mother. First, a picture 16 thereof is included of the daughter of the author printed therein or a blank space on a page for attachment of a photo of a daughter of a purchaser of the book.

FIG. 3S is an illustration on the back of the picture page 16 that has inspirational writing 17 designed to connect young reader's with the used of the book as a sweet tool to grow yearly.

FIG. 3T, FIG. 3U, FIG. 3V, FIG. 3W, FIG. 3X, FIG. 3Y, FIG. 3Z are illustrations representing three full double sided pages of writings ending in another final page having one side concluding this writing.

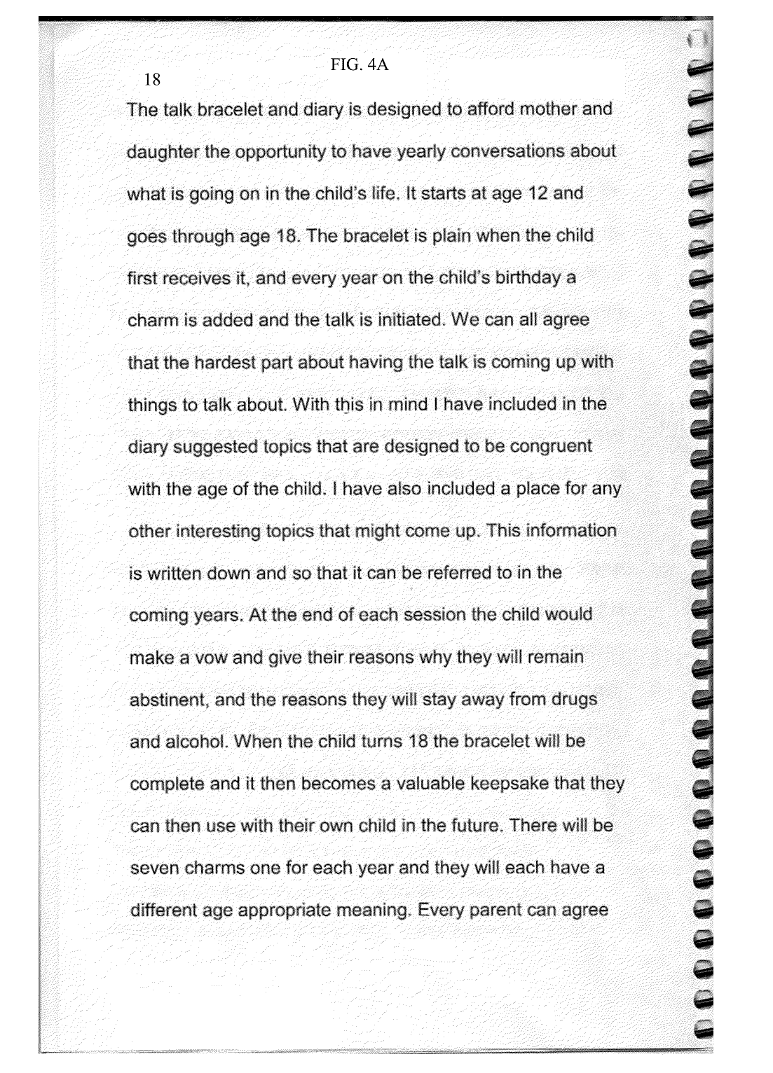

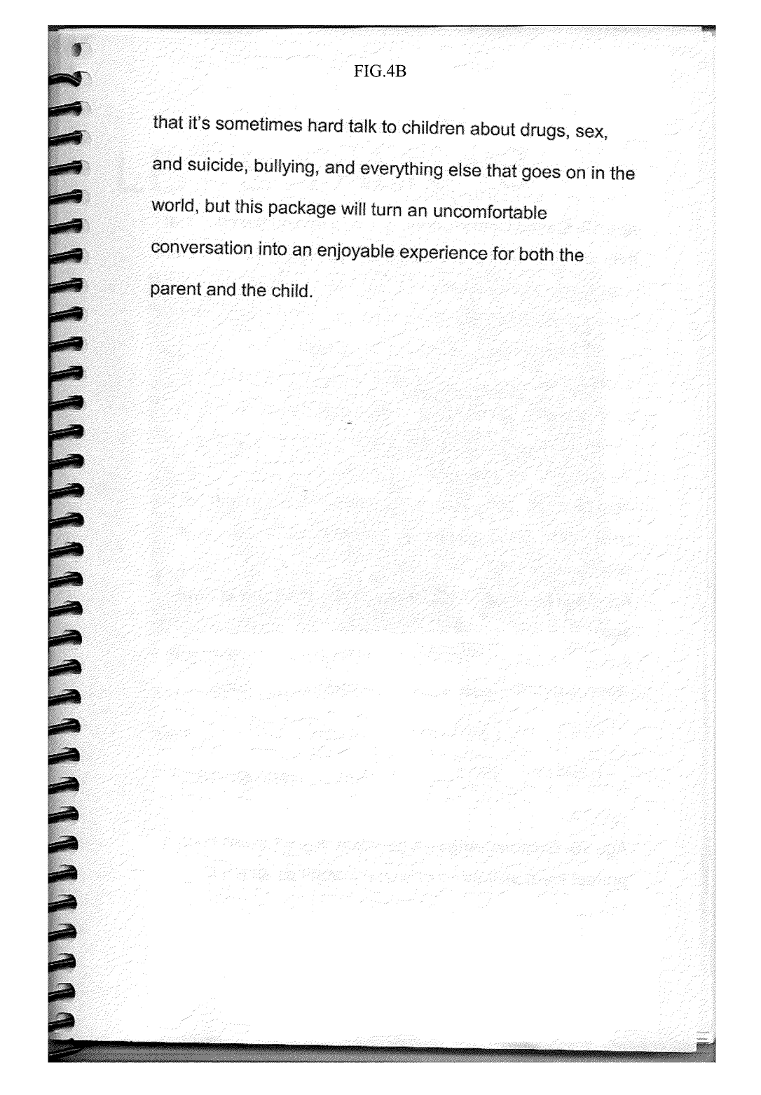

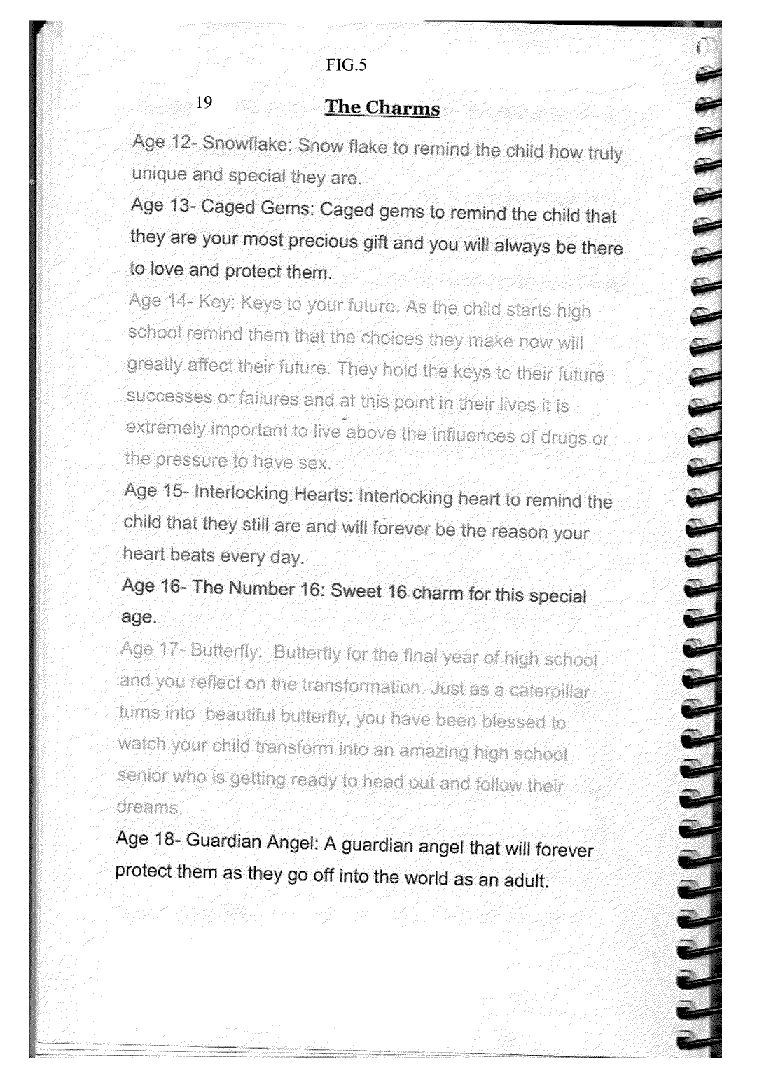

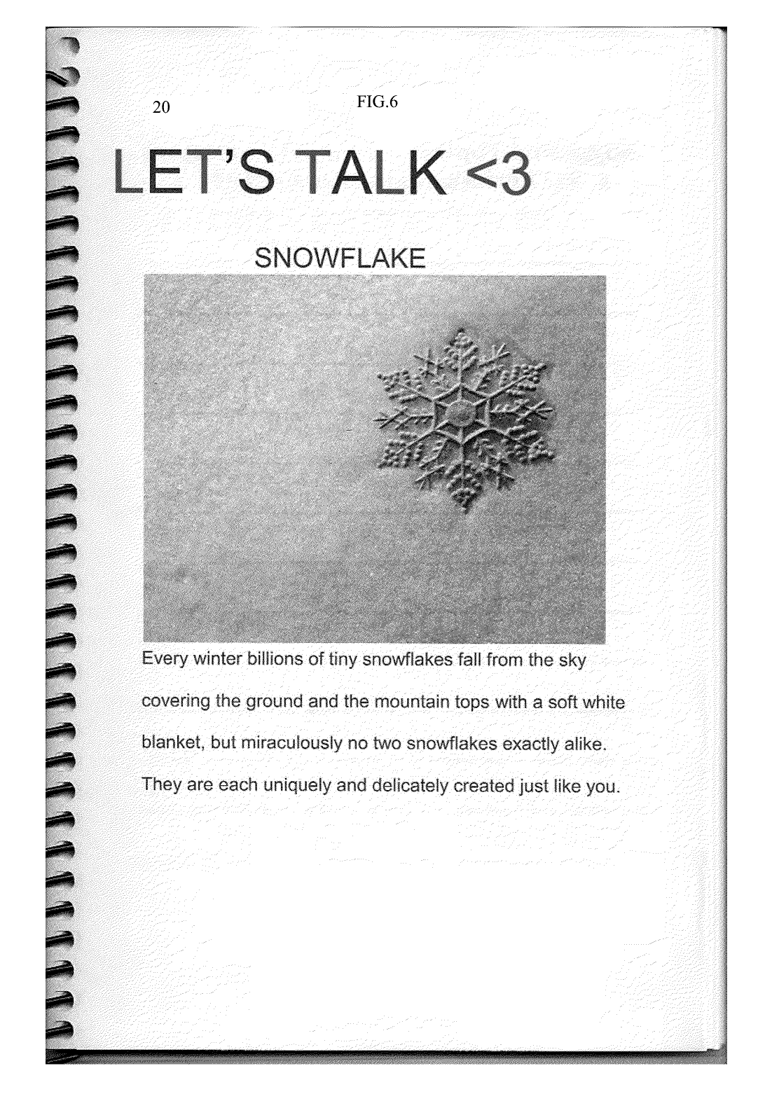

FIG. 4A, FIG. 4B are illustrations of a two page description 18 of the meaning of the Talk Bracelet & Bonding System.

FIG. 5 is an illustration of a page having a description 19 of each of the Charms and their respective meanings.

FIG. 6 is an illustration of the first page of the first year used in the Bonding System 5. Here an image representing that year is printed therein on a first page 20 of that year; further, a poetic description or motto representing the challenges, emotions, and or goals therefore is also printed in proximity to the imagery thereon.

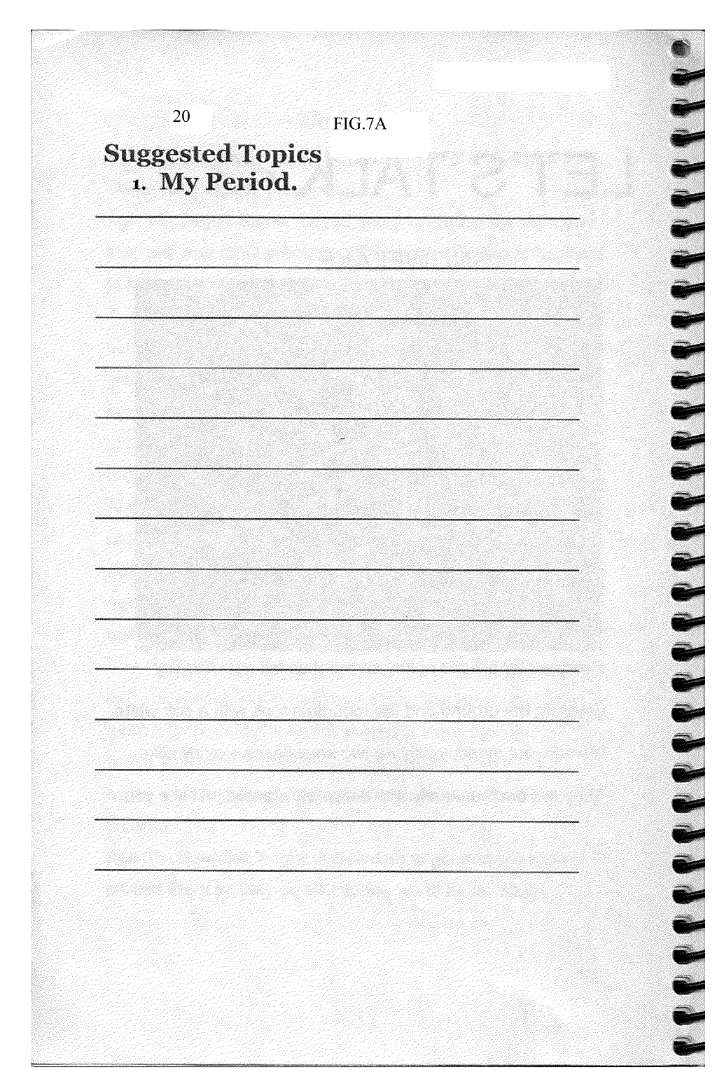

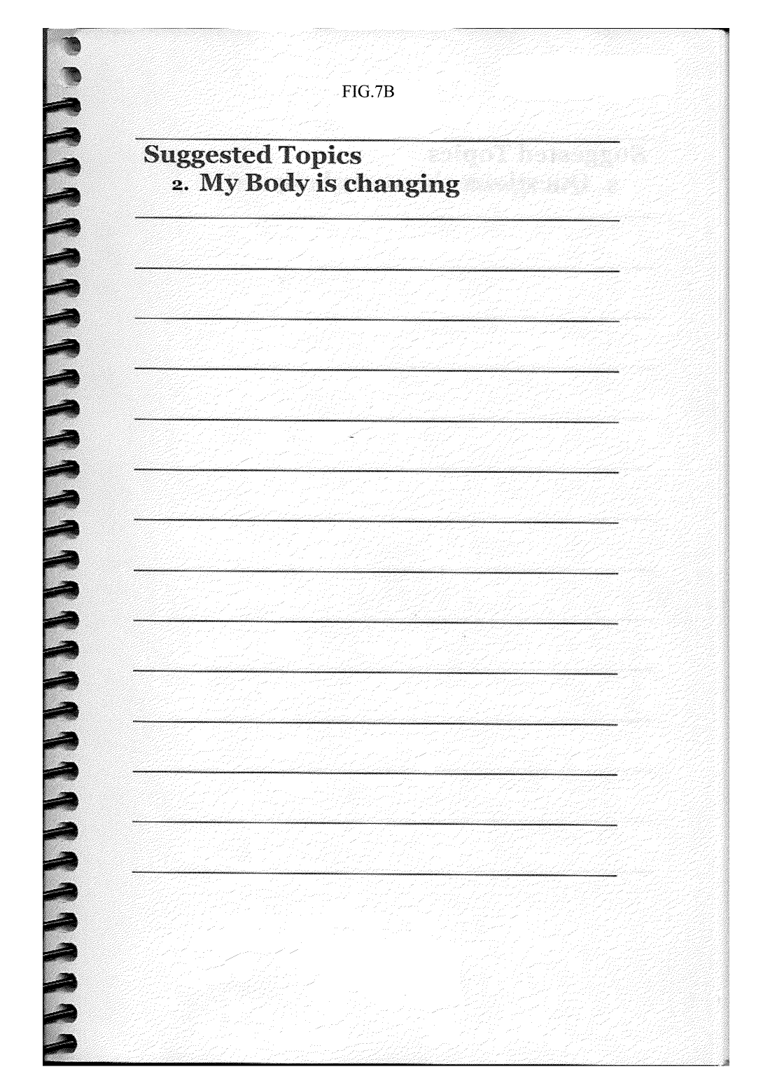

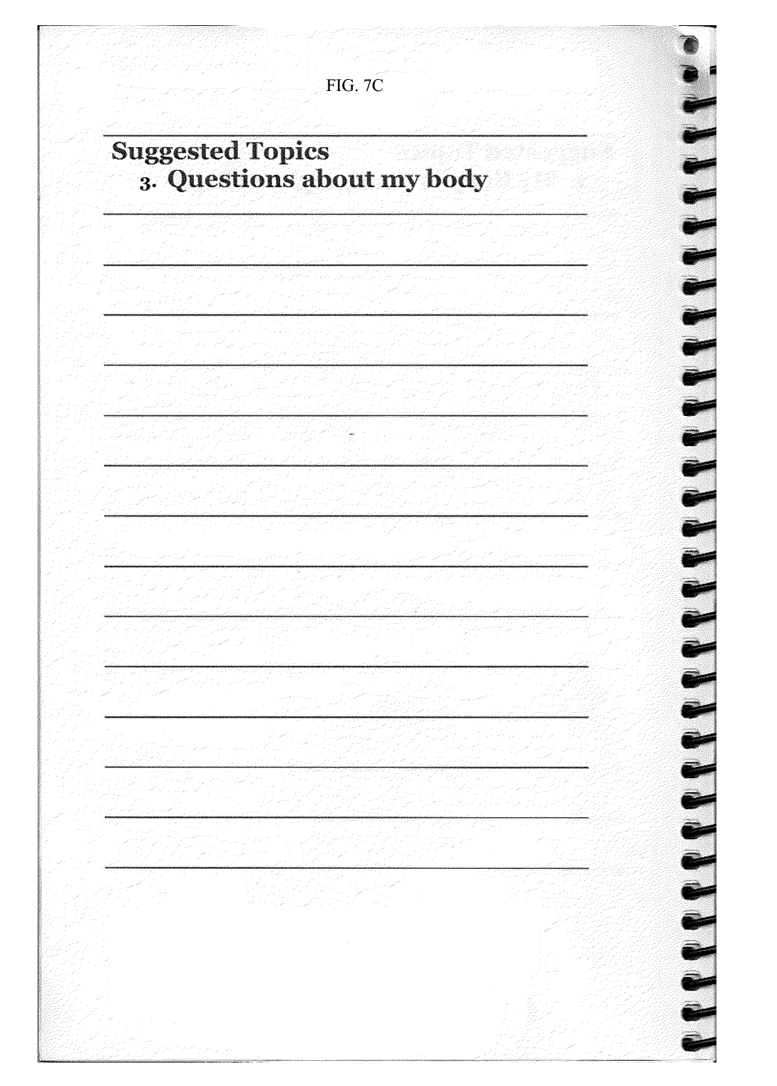

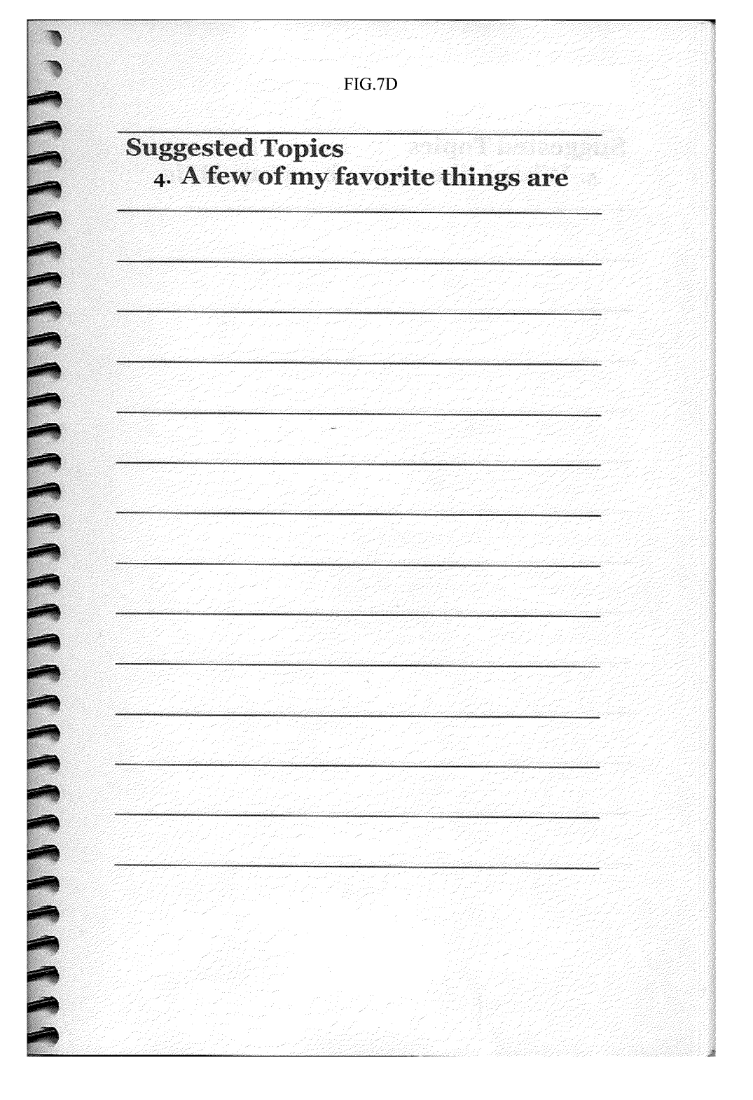

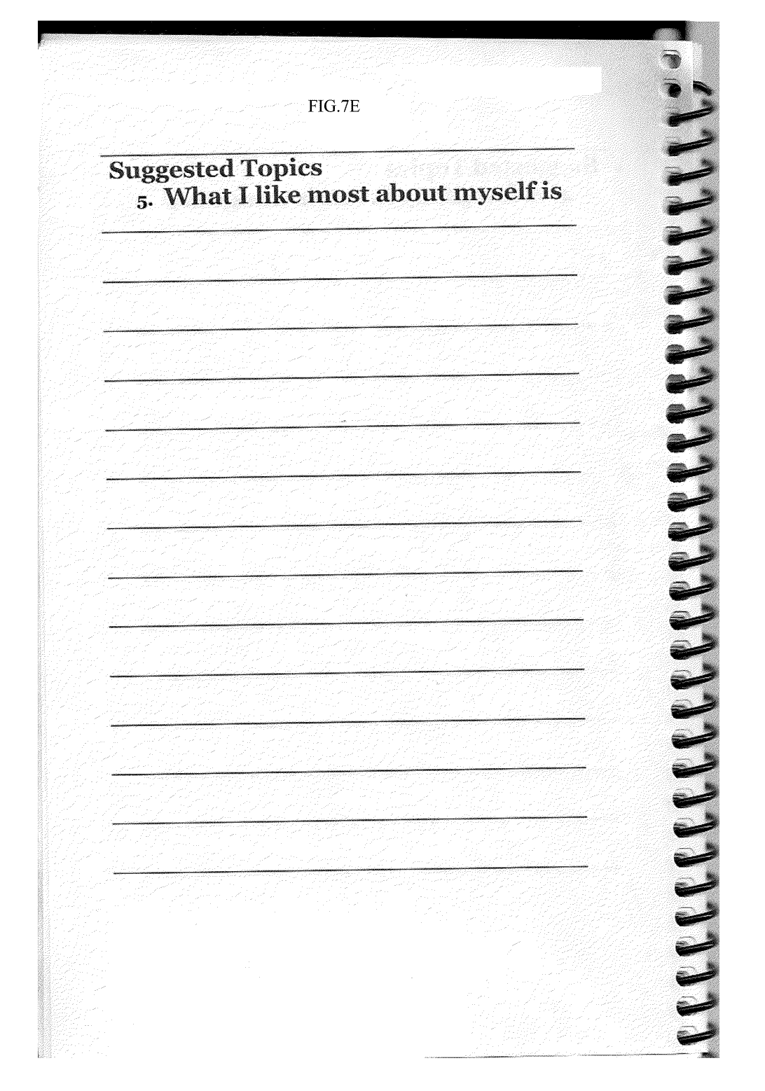

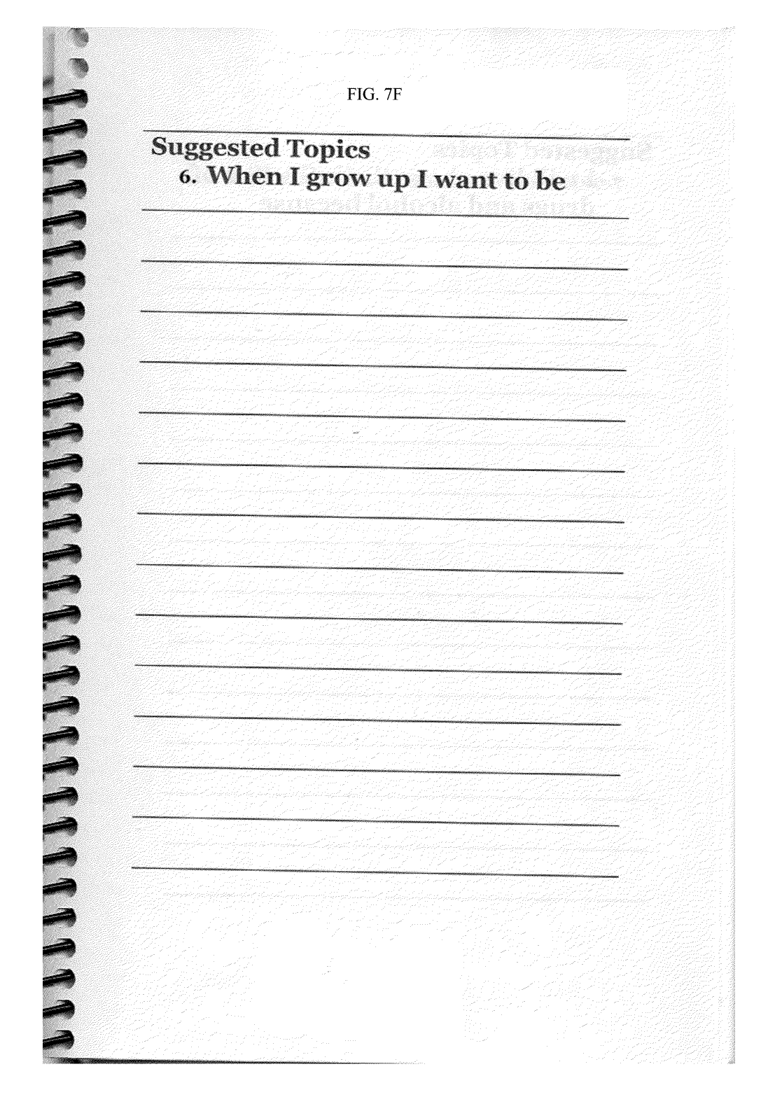

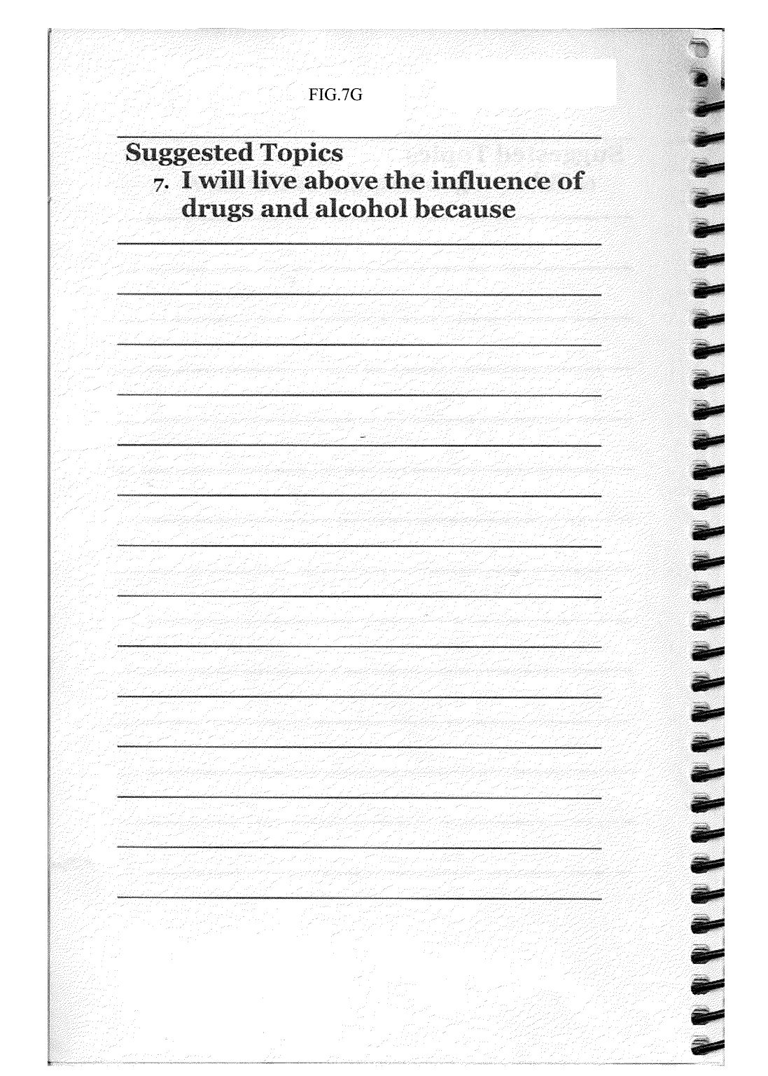

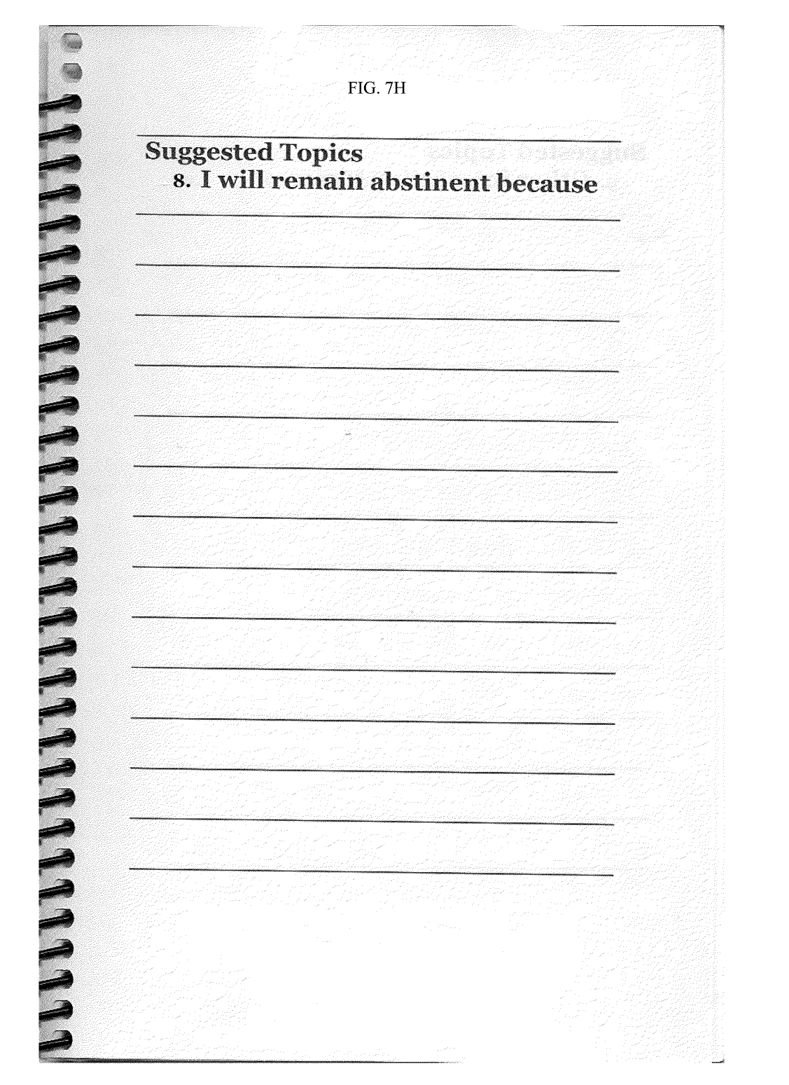

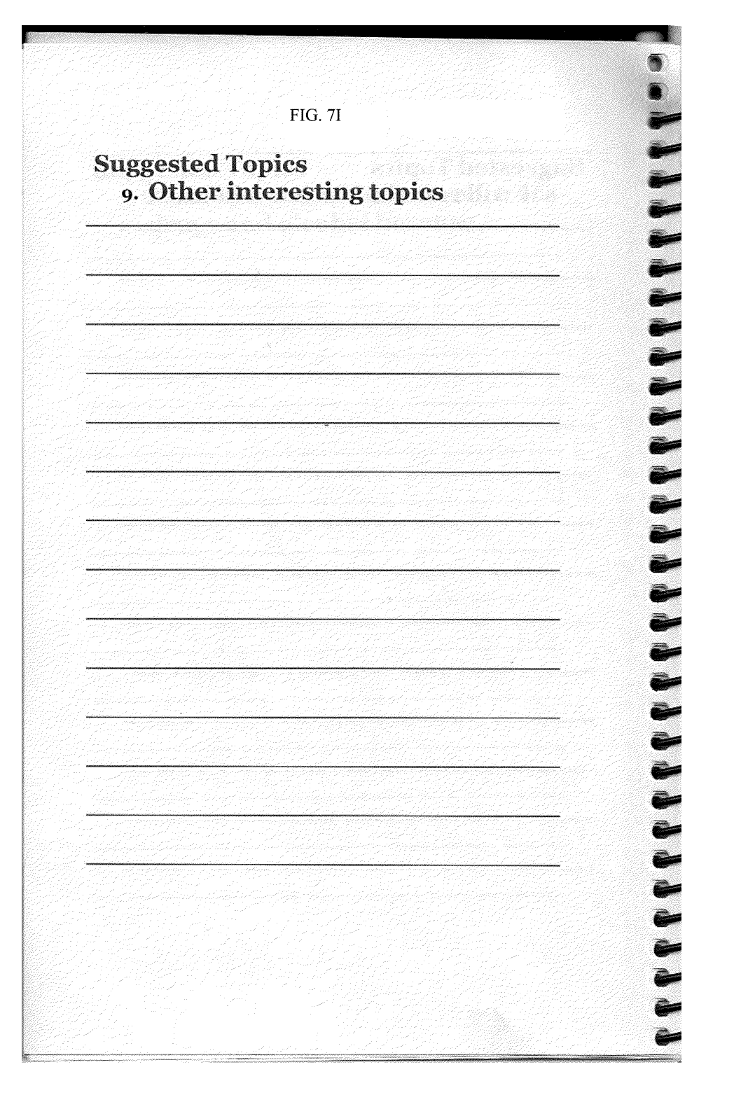

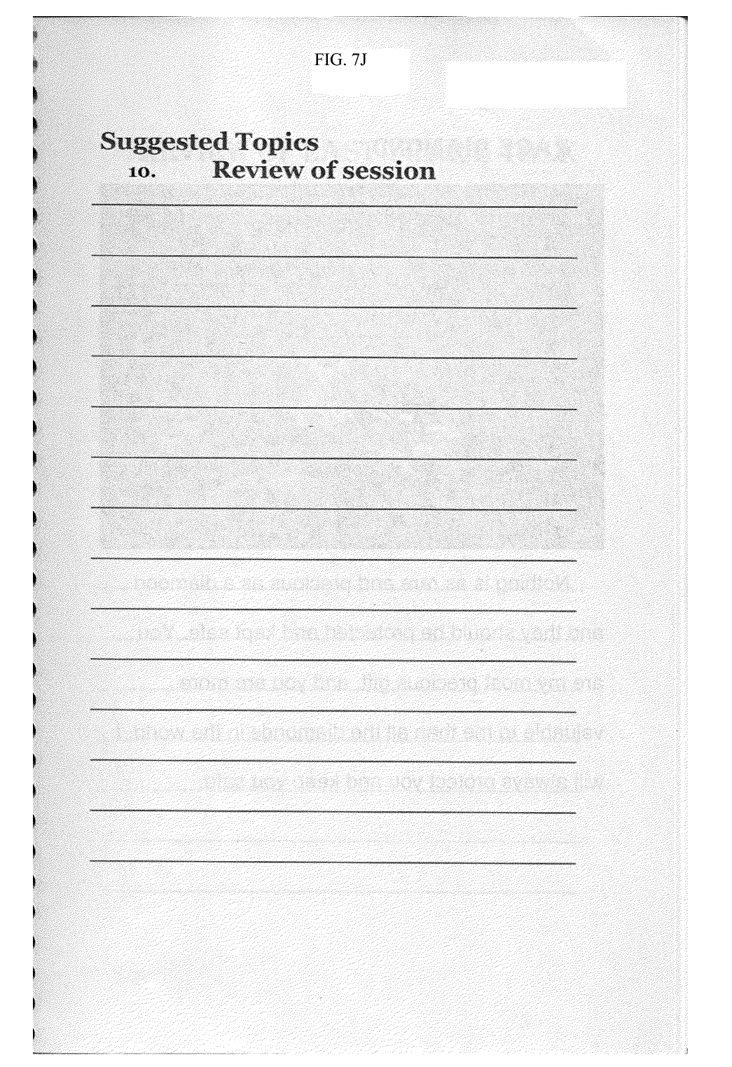

FIG. 7A, FIG. 7B, FIG. 7C, FIG. 7D, FIG. 7E, FIG. 7F, FIG. 7G, FIG. 7H, FIG. 7I, FIG. 7J. are illustrations of the first year discussion topics the child is to receive a Charm 4 representing the passing of a new stage in her life; this coming of age is assisted with the Bonding System group of suggested topics 21 gathered from typical problems, needs, and challenges associated with the specific age of the participating young woman. For example, My Period, My Body is Changing, Questions About My Body, A Few of My Favorite Things Are, What I Like Most About Myself, When I Grow Up I Want to Be, I Will Live Above the Influence of Drugs and Alcohol because, I Will Remain Abstinent Because, Other Interesting Topics, Review of Session.

As each of these items are discussed the young user is encouraged by her parent to partake of these issues with here thereby causing an emotional bond to grow between. The mother also encourages her daughter to make notations or descriptions directly under each aforementioned topic in lined or unlined areas that are utilized for this purpose. Thus, a record of the thoughts, feelings, and resolutions for each year are forever encoded into the Bonding System that can be reviewed year after year.

Each subsequent year begins either on a new page or starts on the back of the end page of the previous year. As the new stage or year commences another image having its own poetic description or motto representing the challenges, emotions, and or goals therefore is also printed in proximity to the imagery thereon. The first page of this new year is a lined or unlined page for REVIEW OF LAST YEAR'S TALK. Here a daughter is encouraged to recall the experience from the previous year's discussion with here parent and make any notations regarding her emotions, thought, or goals gleaned therefrom.

This new year likewise includes a series of topics on unlined or lined pages for discussion of various, emotional, educational, personal, relationship, decision making, religious, romantic, and other problems associated with youth. As each of these items are discussed the young user is encouraged by her parent to partake of these issues with here thereby causing an emotional bond to grow between. The mother encourages her daughter to make notations directly under each topic in lined or unlined areas that are utilized for this purpose. Thus, a record of the thoughts, feelings, and resolutions for each year are forever encoded into the Bonding System. This will be utilized in the upcoming year discussion to set the tone of the future topics as they continue, change and grow from the previous year. The final stage is as in the previous year a Review of Session thereby ending this particular year.

Each of the years repeat this sequence for a total of seven years and charms that are awarded to the child as she proceeds to maturity. The record she makes for herself can assist her in the difficulties involved in growing up in a complex society that does not value purity or sobriety. Thus, by furthering the intercommunication between parent and child and stressing the parental values and emotional engagement with her daughter a positive psychological and spiritual impact can be made on her.

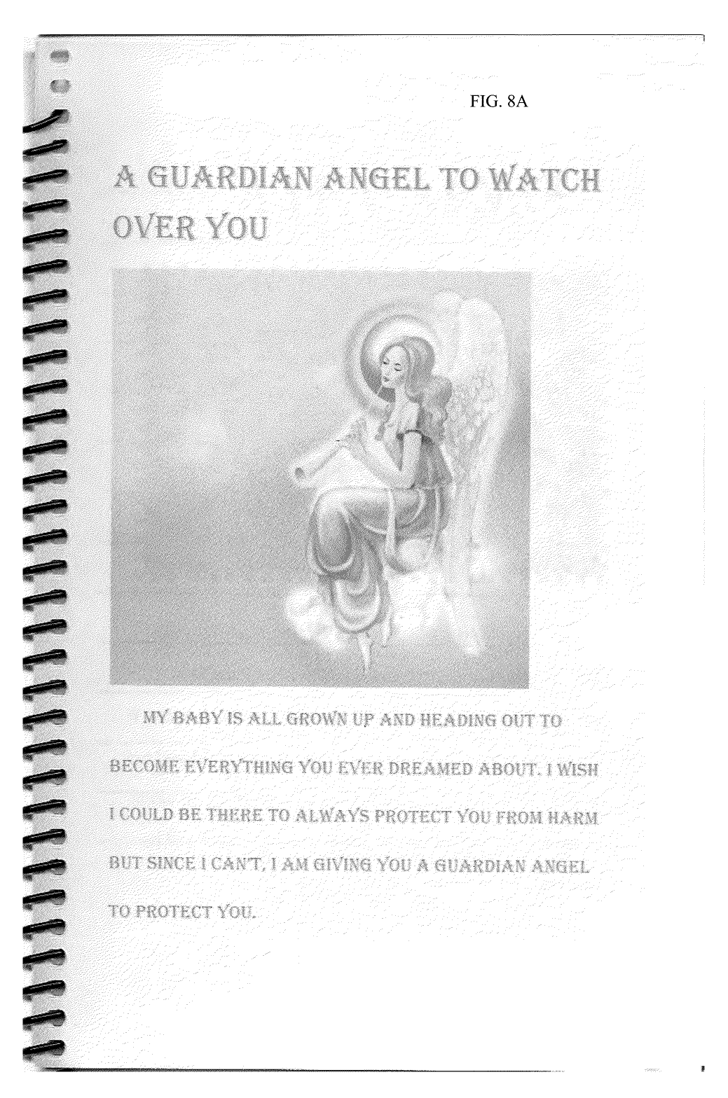

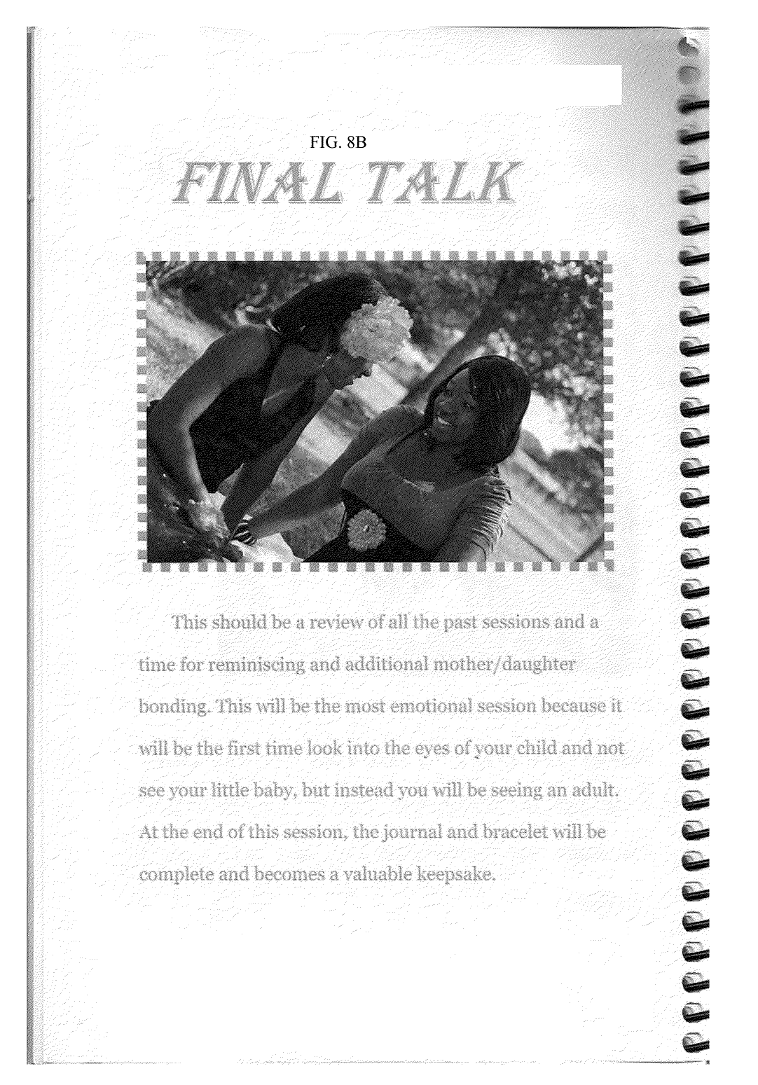

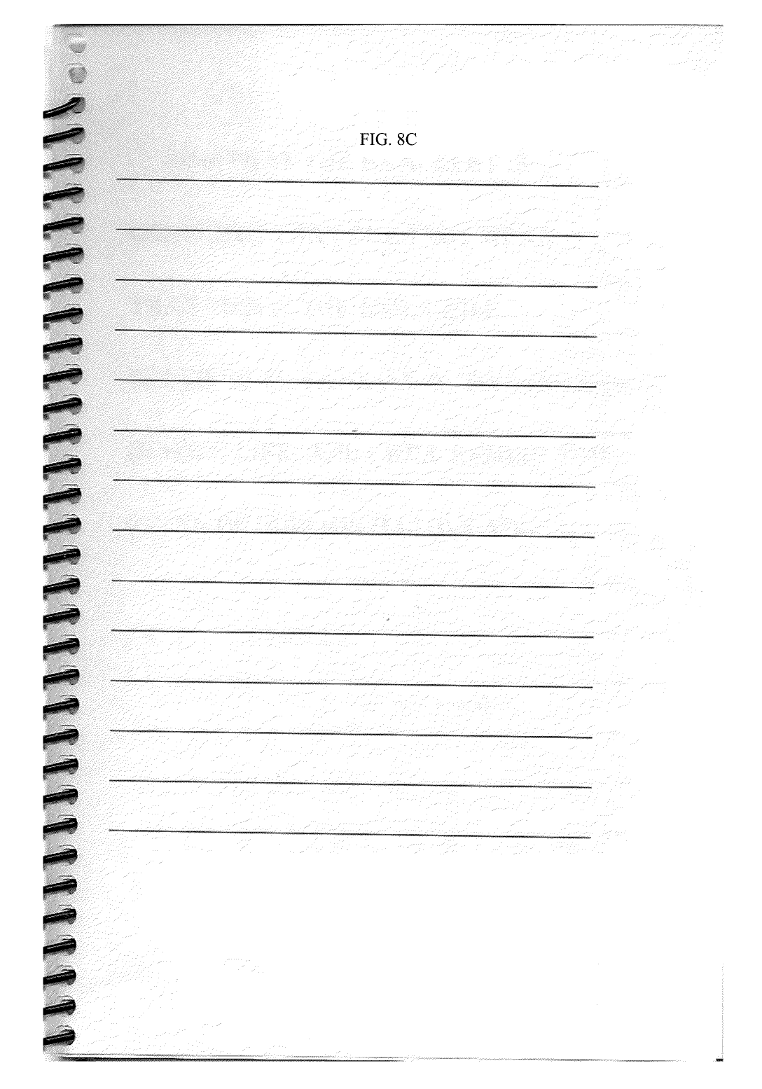

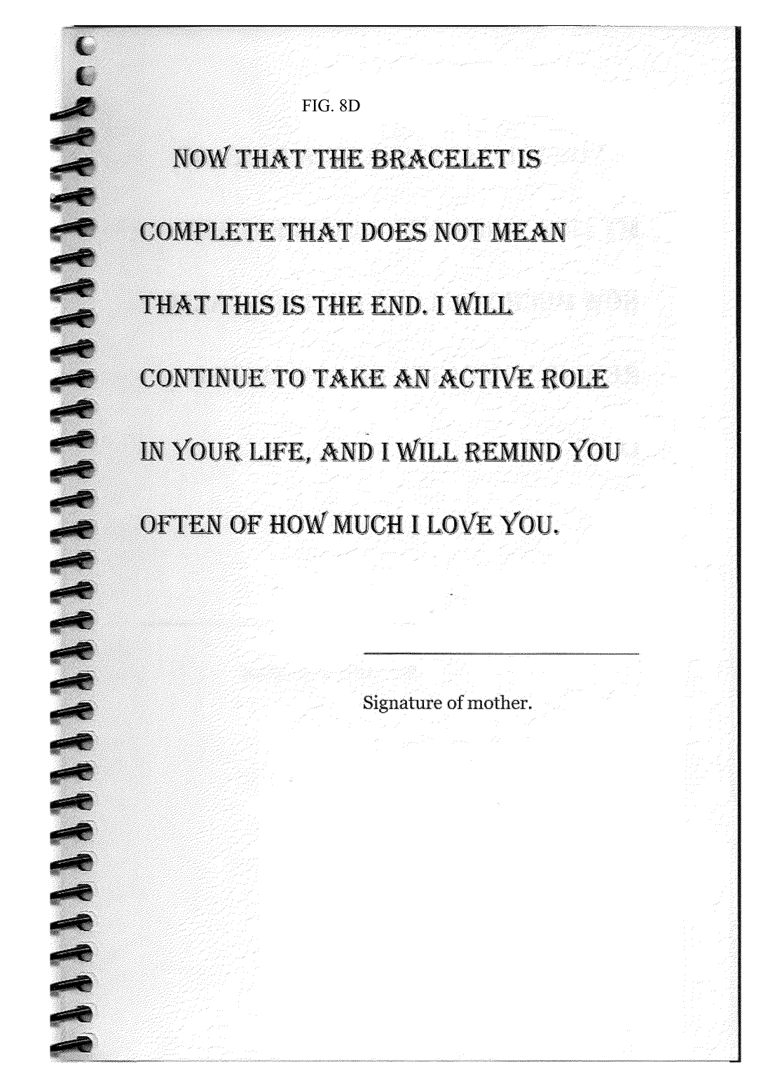

FIG. 8A is an illustration of the Guardian Angel relating to the final charm; like all other stages, it is represented by an image and a poetic proximal statement. FIG. 8B is an illustration of the back of the previous page that has an image of a mother daughter pair or a space for the attachment of a photo thereof and a statement of the finality of the Final Talk as the Bracelet is complete. FIG. 8C is the next page and is a double sided page having lines thereon.

FIG. 8D is the final page and is a double sided page having a Mother's declaration and signature space on one side and a Daughter's declaration and signature space on the other side in FIG. 8E. The spiral or bound book ends in a hard cardboard end sheet.

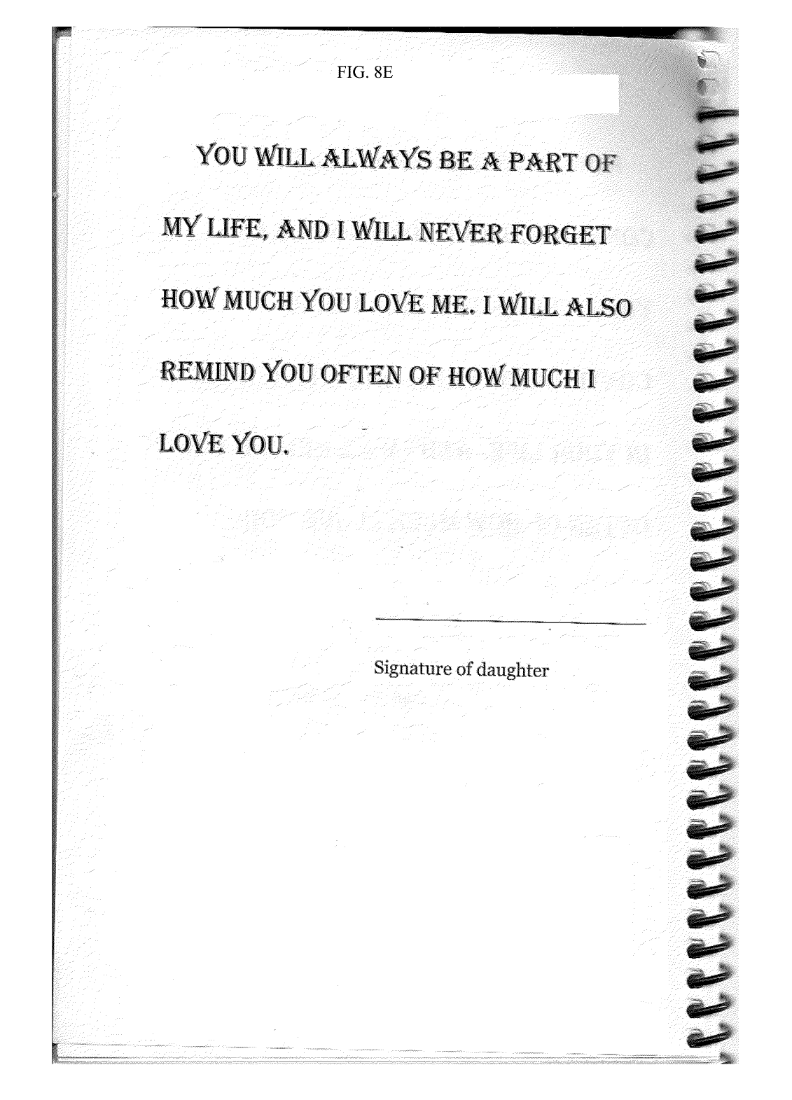

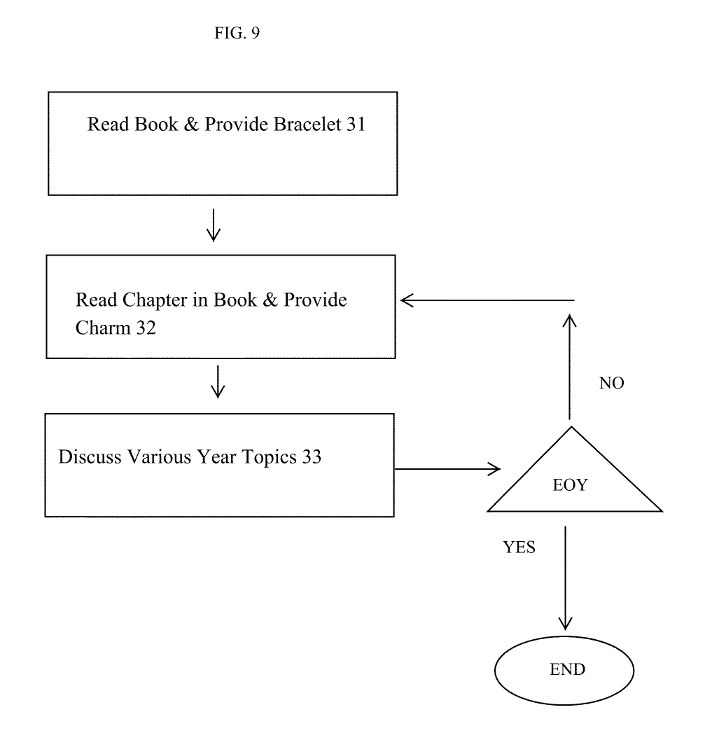

FIG. 9 presents a flowchart of how the Bonding System is to be used in the Talk Bracelet & Bonding System in an embodiment herein. First, a user reads the book and provides 31 her daughter with a charm bracelet. Next, the mother reads the book and provides 32 the daughter with a charm 4 beginning the sequence of years that cover the entire growth period thereof. Then the user is invited to discuss 33 various topics within a particular year. The process repeats 32-33 as long as this is not the final year. If it is the final year then the process ends and the two parties, mother and daughter, are invited to sign their respective statements at the end of the book.

Thus, the Talk Bracelet and Bonding System teaches how a mother and daughter can bond during certain coming of age landmarks that take place in a young woman's life. Further, it shows how they can learn from each stage and grow therefrom in a deepening relationship through the years. Additionally, both the Bonding System and Talk Bracelet along with its charms represent durable mechanisms by which a child can maintain a lifelong record of the passing of time and have a keepsake thereof that stands the test of time.

The above-described embodiments are merely exemplary illustrations of implementations set forth for a clear understanding of the principles of the invention. Many variations, combinations, modifications or equivalents may be substituted for elements thereof without departing from the scope of the invention. For, example, whilst each of the first six years has been described having various pages of discussion topics, the last year, the seventh, the guardian angel year has been described as only having a FINAL TALK discussion. This can be modified by having various thematic discussion topics as in all the previous six charm years. Therefore, it is intended that the invention not be limited to the particular embodiments disclosed as the best mode contemplated for carrying out this invention, but that the invention will include all the embodiments falling within the scope of the appended claims.

What is claimed is:

1. A bonding tool comprising:
a bracelet having a length and two ends thereof such that the length terminates in a clasp attachment at either end so that the clasp attachments can be engaged together and
a first signature charm loaded onto the bracelet.

2. The bonding tool of claim 1, further comprising:
a second signature charm loaded onto the bracelet.

3. The bonding tool of claim 1, further comprising:
a plurality of signature charms loaded onto the bracelet.

4. The bonding tool of claim 1, wherein the signature charm comprises:
a thematic charm.

5. The bonding tool of claim 1, wherein the signature charm comprises:
a thematic charm.

6. The bonding tool of claim 1, wherein the signature charm further comprises interaction with a bonding system related to the signature charm.

7. The bonding tool of claim 2, wherein the plurality of signature charm further comprises interaction with a bonding system related to the plurality of signature charms.

8. A bonding system comprising:
a young woman's personal growth handbook having a plurality of leaves including a sequence of chapters therein such that
the chapters each have an introductory image and statement relating to a unique bracelet charm.

9. The bonding system of claim 8, wherein each of the chapters further comprises:
a set of discussion topics relating to a future year in the life of the young woman.

10. The bonding system of claim 9, wherein each of the discussion topics further comprises:
a new page having a discussion title at a top thereof and a writing space below the aforementioned title.

11. The bonding system of claim 8, further comprising:
a mother end statement.

12. The bonding system of claim 11, further comprising:
a mother signature space.

13. The bonding system of claim 8, further comprising:
a daughter end statement.

14. The bonding system of claim 11, further comprising:
a daughter signature space.

15. A method of using a thematic signature device comprising steps of:
reading a beginning of a chapter in a bonding tool
providing the thematic signature device to a user by attachment to a bracelet thereon.

16. The method of claim 15, further comprising the steps of:
reading a discussion topic.

17. The method of claim 16, further comprising the steps of:
inscribing ideas relating to the discussion topic in the bonding tool.

18. The method of claim 17, wherein the steps of:
reading a beginning of a chapter in a bonding tool
providing the thematic signature device to a user by attachment to a bracelet thereon and
reading a discussion topic and inscribing ideas relating to the discussion topic in the bonding tool are repeated until the end of the bonding tool.

19. The method of claim 15, further comprising the steps of:
reviewing the previous year's discussion at start of new year.

20. The method of claim 15, further comprising the steps of:
reviewing the current year's discussion at end of a year.
